(19) United States
(12) Patent Application Publication
(10) Pub. No.: US 2016/0052296 A1
(43) Pub. Date: Feb. 25, 2016

(54) Automated Paint Application System and Related Method

(71) Applicant: John Grimes, Lampman (CA)

(72) Inventor: John Grimes, Lampman (CA)

(21) Appl. No.: 14/837,453

(22) Filed: Aug. 27, 2015

Related U.S. Application Data
(63) Continuation-in-part of application No. 13/776,120, filed on Feb. 25, 2013.

(51) Int. Cl. B41J 3/407

(52) U.S. Cl. CPC B41J 3/4073

(57) ABSTRACT

An automated paint application system for automatically, safely and efficiently reproducing a high resolution image on an area of a surface located in an uncontrolled environment and a related method for reproducing a high resolution image on a surface in an uncontrolled environment are disclosed. The automated paint application system features a robotic painting machine which uses a vectorized format of the image to generate a plurality of paint paths which an applicator nozzle of the robotic painting machine follows about the surface in order to form the image. The robotic painting machine includes a plurality of paint conduits each connected by a valve to at least one applicator nozzle and usable for respectively transferring a different coloured paint in a manner such that the valves are controllable to dispense one of the different coloured paints or to form a combination colour thereof.

This application is a continuation-in-part of U.S. parent application Ser. No. 13/776,120, filed Feb. 25, 2013.

### FIELD OF THE INVENTION

The present invention relates generally to a paint applicator and more specifically it relates to an automated paint application system for automatically, safely and efficiently painting an image onto a structure.

### BACKGROUND

Large structures such as water towers, grain storage buildings and the like often have large images painted on them. For example, water towers often have the name of a town or city painted thereon, sometimes with an additional image. Large buildings will often have advertisements or signs painted on their sides.

When painting images on such large structures, it is often required that a painter go up on a scaffolding or other device and manually paint the image. While this methodology has worked in the past, it has often lead to injuries or even death due to the hazards related with being suspended next to a large structure at a significant height above the ground.

Because of the inherent problems with the related art, there is a need for a new and improved automated paint application system for automatically, safely and efficiently painting an image onto a structure.

Furthermore, such large structures typically present desirable locations for applying graffiti thereto from the viewpoint of vandals. A proven method to deter such vandals is to strategically place murals in areas that will beautify a community. Most of the time, a mural will not be touched by graffiti vandals. In addition to being suited as a form of deterrence, murals can depict the local history of an area or community, which may serve to teach citizens about their community. Furthermore, murals are inexpensive to coordinate in comparison to the cost involved with constantly removing graffiti.

Thus, it is desirable to provide a unique solution for efficiently and economically painting large images such as murals to deter vandals from vandalizing structures in a community by tagging such structures.

### SUMMARY OF THE INVENTION

According to one aspect of the invention there is provided a method for reproducing a high resolution image on an area of a surface in an uncontrolled environment through application of paint on said surface comprising:

providing the image in a format which is storable on a computing device having memory, the image having one or more constituent hues each including at least one shade and at least one level of saturation;

providing an automated paint application system for applying the paint to the surface, the automated paint application system including:
a robotic painting machine comprising a base and a paint applicator supported thereon in a manner so as to be movable relative to the base;
the paint applicator carrying at least one applicator nozzle for spraying the paint onto the surface in a spraying mode of said at least one applicator nozzle;
a control system actively directing one of said at least one applicator nozzle that is in the spraying mode about the surface in the uncontrolled environment;
preparing the image for reproduction on the surface including:

processing the image into a vectorized format usable by the automated paint application system;

generating one or more paint paths which collectively form the image with the vectorized format thereof, each paint path having one of said constituent hues of the image and a respective spatial path about the surface and being usable by the control system of the automated paint application system in a manner so as to be traceable on the surface in continuous motion of the paint applicator;

applying the paint onto the surface using the automated paint application system by following said one or more paint paths so as to form the image.

In the embodiment described in more detail hereinafter, implementation of the image's vectorized format to generate the paint paths by which the image is formed may provide several advantages over prior art paint application systems, at least some of which are not realizable using bit-map formatted images such as raster or pixel-based images. Such advantages include (i) ability to scale or size (and resize) the image according to the area of the surface without hindering the quality or resolution of the image; (ii) ability to organize the image into smaller sections for more efficient and accurate painting thereof; (iii) ability to reproduce the image by painting in the continuous motion (at least as it pertains to individual image sections), which typically has resemblance to motion of a human hand; and (iv) ability to easily perform shading (and shadowing) which adds depth and typically a more realistic appearance of the image on the surface. By painting in the way of tracing paint paths, the system may also provide active collision avoidance with features of the surface such as protrusions, miscellaneous objects in proximity to the surface such as electrical cables and water pipes lying along or adjacent the surface, and miscellaneous objects disposed in or on the surface such as windows, brackets, and antennas. The paint paths may also afford management of the image relative to the surface features so as to accommodate such surface features (also including openings, recesses, etc.) such that the image reproduced on the surface matches as closely as possible to the image as presented on a screen, for example. Collision avoidance and management of surface features allow the robotic painting machine to be more readily operated in uncontrolled environments, unlike a paint booth where ambient conditions are maintained at known values, in which it may not be possible to determine all of such features of the surface prior to implementing the method of the present invention or in the case that new obstacles may appear because of the uncontrolled nature of the painting environment.

‘Paint’ as used in this specification refers to a colored substance that is spread over a surface and dries to leave a thin decorative or protective coating. For example, ‘paint’ may comprise spray paint and moss spores.

‘Hue’ as used in this specification refers to pure colours.

‘Shade’ as used in this specification refers to intensity of a colour compared to or as distinguished from one nearly like it.

‘Saturation’ as used in this specification refers to intensity of a colour expressed as a degree to which it differs from white.

Preferably, the step of preparing the image comprises a step of sizing the image which is in the vectorized format according to the area of the surface on which the image is to be applied.

Preferably, the step of preparing the image comprises a step of dividing the image into a plurality of image sections on the area of the surface on which the image is to be applied.

The image sections may be sized based on a paint coverage area of the paint applicator in a stationary position of the base at the surface.

Alternatively or additionally, the image sections may be sized such that movement of the robotic painting machine from a first position thereof at one of the image sections to a second position of the robotic painting machine located at another one of the image sections that is adjacent thereto is minimized.

Preferably, the step of applying the paint comprises reproducing each image section one by one. That is, each image section is reproduced successively one after the other.

Preferably, the step of preparing the image comprises a step of processing the image into a plurality of image layers each of which is defined by one of the constituent hues of the image such that at least one paint path forms one of the image layers.

It is preferred that the step of applying the paint comprises applying each image layer one by one. That is, each image layer is reproduced one at a time.

Preferably, the step of applying the paint comprises applying the image layers at one of the image sections prior to reproducing another one of the image sections.

Preferably, the step of processing the image into the plurality of image layers includes mapping said at least one shade within each image layer.

Preferably, the step of applying the paint comprises a step of balancing an actual magnitude of velocity of the continuous motion of the paint applicator about the surface and an actual pressure of the one of said at least one applicator nozzle in the spraying mode for maintaining a consistent density of the paint which is applied based on a ratio of a pre-specified magnitude of the velocity of the motion of the paint applicator about the surface and a reference pressure of said applicator nozzle in the spraying mode for said pre-specified magnitude of the velocity.

Preferably, the step of balancing the actual magnitude of the velocity of the motion of the paint applicator and the actual pressure of said applicator nozzle in the spraying mode comprises determining the actual magnitude of the velocity of the motion about the surface and adjusting the pressure of said applicator nozzle in the spraying mode to maintain the ratio of the pre-specified magnitude of the velocity of the motion and the reference pressure of said applicator nozzle.

Preferably, the step of applying the paint comprises a step of adjusting a pressure of the one of said at least one applicator nozzle in the spraying mode to produce the respective shade of the respective constituent hue.

Preferably, the step of adjusting the pressure of said applicator nozzle in the spraying mode to produce the respective shade comprises changing said pressure of said applicator nozzle in the spraying mode from a reference pressure thereof which is based on a pre-specified magnitude of velocity of the continuous motion of the paint applicator about the surface for maintaining a prescribed density of the paint which is applied.

In one arrangement, the method includes a step of mixing a set of basic hues of paint at the robotic painting machine to form the respective constituent hue of the image.

The method may include a step of calculating a sufficient amount of paint for the constituent hue based on the respective paint path so as to cover the respective paint path where said step of calculating the sufficient amount of paint is performed prior to the step of mixing the set of basic hues of paint.

The method may include a step of transferring the basic hues of paint across a distance from a supply location of the basic hues of paint to the robotic painting machine that is located at the surface.

The method may include a step of scanning the surface in first and second dimensions collectively defining a plane which is substantially parallel to the surface and in a third dimension normal to the surface using distance sensors disposed on the robotic painting machine to detect surface features as the robotic painting machine is displaced about the surface in said plane so as to provide a map of the surface features in the first, second, and third dimensions.

Preferably, a depth of the surface in the map as measured in the third dimension is measured with respect to a pre-specified distance at which the one of said at least one applicator nozzle in the spraying mode is to be maintained from the surface.

Preferably, the step of applying the paint comprises a step of managing the motion of the paint applicator relative to the surface so as to avoid collision therewith by using the distance sensors to actively sense for unaccounted surface features which were not detected in the step of scanning the surface as the robotic painting machine moves about the surface and initiating preventative action of the robotic painting machine upon detection of said unaccounted surface features.

Additionally or alternatively (in the instance that the step of scanning the surface is not performed), the step of managing the motion of the paint applicator provides an ability to avoid collision with the surface by using the distance sensors disposed on the robotic painting machine during movement of the robotic painting machine about the surface to detect surface features which protrude towards the one of said at least one applicator nozzle in the spraying mode in a manner so as to be within a pre-specified distance at which the applicator nozzle is to be maintained from the surface and to initiate preventative action to avoid the collision.

The preventative action may include retracting said applicator nozzle in the spraying mode away from the surface and maneuvering the paint applicator about the protruding surface feature so as to paint over said surface feature thereby modifying at least one of the paint paths.

Alternatively, the preventative action may include retracting said applicator nozzle in the spraying mode away from the surface and moving the paint applicator past the protruding surface feature so as to omit said surface feature from painting thereover.

In one arrangement, the image is provided in a bit-mapped format within the step of providing the image and the step of processing the image into the vectorized format comprises converting the image from the bit-mapped format into the vectorized format.

Preferably, said at least one applicator nozzle is rotatably carried on a painting arm of the paint applicator so as to be arranged for aiming said applicator nozzle substantially normal to the surface.

Preferably, the step of applying the paint comprises a step of regulating the actual pressure of the one of said at least one applicator nozzle in the spraying mode within a predetermined pressure range which is with respect to the reference pressure of said applicator nozzle in the spraying mode for maintaining the consistent density of the paint which is applied.

The robotic painting machine preferably includes an applicator pump which generates pressure at the one of said at least one applicator nozzles in the spraying mode and the step of regulating the actual pressure of said applicator nozzle in the spraying mode comprises adjusting an output pressure of the applicator pump based on the actual pressure determined at said applicator nozzle.

The at least one applicator nozzle may form a nozzle assembly which includes an applicator pump and a paint reservoir for containing paint in proximity to said at least one applicator nozzle that are located at an inlet side thereof.

In one arrangement, there is provided a step of purging the nozzle assembly so as to remove paint residue therefrom prior to using said at least one applicator nozzle for application of paint forming a respective one of the constituent hues different than a previous one of the constituent hues which was applied by said applicator nozzle.

In one arrangement, the at least one applicator nozzle comprises two applicator nozzles. One of the two applicator nozzles is in the spraying mode in order to actively perform the step of applying the paint onto the surface and another one of the two applicator nozzles is in an idle mode.

Preferably, there is provided a step of queuing said another one of the two applicator nozzles in the idle mode for application of paint forming another one of the constituent hues of the image different from a current one of the constituent hues being applied that is performed in parallel with the step of applying the paint onto the surface.

Each applicator nozzle preferably forms the nozzle assembly which includes the applicator pump and the paint reservoir for containing paint in proximity to the respective applicator nozzle that are located at an inlet side of the respective applicator nozzle.

Preferably, the step of queuing said applicator nozzle in the idle mode comprises a step of purging the nozzle assembly having said applicator nozzle which is in the idle mode so as to remove paint residue therefrom.

Preferably, the step of queuing said applicator nozzle in the idle mode comprises a step of transferring said another one of the constituent hues of the image which is different from the current one of the constituent hues being applied into the nozzle assembly having said applicator nozzle which is in the idle mode such that said applicator nozzle in the idle mode is readied for operating in the spraying mode.

According to one aspect of the invention there is provided a robotic painting machine for reproducing a high resolution image on an area of a surface in an uncontrolled environment through application of paint on said surface comprising:

a base which is elongate in a longitudinal axis along the surface;

an upstanding support boom carried on the base so as to be movable along the longitudinal axis of the base;

a paint applicator supported on the upstanding support boom in a manner so as to be movable across a height axis of the support boom which is transverse to the longitudinal axis of the base;

the paint applicator including at least one applicator nozzle for spraying the paint onto the surface in a spraying mode of said at least one applicator nozzle that is carried on a painting arm;

the painting arm being movably supported on the support boom so as to be movable in a depth axis which is transverse to the height axis of the support boom and to the longitudinal axis of the base;

a paint delivery system operatively connected to said at least one applicator nozzle for transferring the paint thereto;

a drive system operatively coupled to each one of the upstanding support boom, the paint applicator, and the painting arm for driving movement thereof;

and a control system directing motion of one of said at least one applicator nozzle in the spraying mode about the surface in the uncontrolled environment.

Preferably, said at least one applicator nozzle is pivotally supported on the painting arm so as to be movable about an upstanding axis which is transverse to the depth axis and parallel to the height axis of the support boom for aiming said at least one applicator nozzle substantially normal to the surface.

In one arrangement, the paint delivery system comprises a plurality of paint conduits each connected by a valve to said at least one applicator nozzle and usable for respectively transferring a different coloured paint and a controller operable to selectively control the valves of the respective paint conduits for dispensing the paint that is transferred by the respective conduit. Preferably, the controller is operable in a first mode such that one of the different coloured paints is selectable and in a second mode such that a combination colour is formed including in combination two or more of the paints from the paint conduits.

In one arrangement, the base comprises a main portion and an end portion pivotally coupled thereto so as to be pivotally movable between a first position in which the end portion is aligned with the main portion along the longitudinal axis of the base and a second position in which the end portion is folded relative to the main portion so as to be located outside of the longitudinal axis of the base such that the support boom is movable between a working position in which the height axis of the support boom is transverse to the longitudinal axis of the base and a stored position in which the height axis is parallel to the longitudinal axis of the base such that the support boom is lying parallel to the longitudinal axis of the base.

The robotic painting machine preferably includes a plurality of distance sensors disposed at strategic locations at or adjacent a distal end of the painting arm so as to be near said at least one applicator nozzle for detecting obstacles in a path of motion of the one of said at least one applicator nozzle in the spraying mode, said strategic locations including first and second locations facing in each direction along the longitudinal axis of the base, third and fourth locations facing in each direction along the height axis of the support boom, and a fifth location facing in a first direction of the depth axis that is arranged to face the surface.

The at least one applicator nozzle preferably forms a nozzle assembly which includes an applicator pump and a paint reservoir for containing paint in proximity to the respective applicator nozzle that are located at an inlet side of the respective applicator nozzle.

Preferably, there is provided a purging assembly operatively coupled to the nozzle assembly and arranged for transferring a purging fluid through the nozzle assembly so as to remove paint residue therefrom.

In one arrangement, the purging assembly comprises a purging pump and a purging reservoir for containing unused purging fluid that are connected to a nozzle outlet side of the applicator pump in order to cooperate with the nozzle assembly so as to transfer the purging fluid therethrough in a reverse direction with respect to a conventional direction of paint flow through the nozzle assembly.

In one arrangement, the at least one applicator nozzle comprises two applicator nozzles each forming the nozzle assembly which includes the applicator pump and the paint reservoir for containing paint in proximity to the respective applicator nozzle that are located at an inlet side of the respective applicator nozzle such that the nozzle assemblies are usable independently of one another in a manner such that the respective nozzle assembly having one of the applicator nozzles in an idle mode is operable while said one of the applicator nozzles in the spraying mode is actively spraying the paint.

Preferably, the paint delivery system is operable in a first mode in which a first one of the nozzle assemblies is selected for transferring the paint thereto and in a second mode in which a second one of the nozzle assemblies is selected for transferring the paint thereto.

According to one aspect of the invention there is provided an automated paint application system for application of paint to an upright structure in a manner so as to form an image on the upright structure that has different colours comprising:

at least one track;

a fastening arrangement for removably securing said at least one track in fixed position extending along said upright structure;

an applicator mount movably secured to said at least one track so as to be movable relative to said upright structure;

a paint applicator for applying the paint to the upright structure that is secured to said applicator mount so as to be movable relative thereto for movement relative to the upright structure, the paint applicator including:
an applicator nozzle;
a plurality of paint conduits each connected by a valve to the applicator nozzle that are usable for respectively transferring a different coloured paint;
and a controller operable to selectively control the valves of the respective paint conduits for dispensing the paint that is transferred by the respective paint conduit;
said controller being operable in a first mode such that one of the different coloured paints is selectable and in a second mode such that a combination colour is formed including in combination two or more of the paints from the paint conduits.

In one arrangement, the plurality of paint conduits converge to a single conduit which terminates at the applicator nozzle.

### BRIEF DESCRIPTION OF THE DRAWINGS

Preferred arrangements of the invention will now be described in conjunction with the accompanying drawings in which:

FIG. 1 is a first upper perspective view of an automated paint application system of the present invention in use.

FIG. 2 is a second upper perspective view of the automated paint application system in use.

FIG. 3 is a top view of a paint applicator of the automated paint application system.

FIG. 4 is a top view illustrating positioning of paint applicators of the automated paint application system with respect to a structure.

FIG. 5 is a top view of a paint applicator of the automated paint application system in use.

FIG. 6 is a schematic illustration of automated paint application system according to the present invention.

FIG. 7A is a perspective view of a first embodiment of robotic painting machine according to the present invention as schematically depicted in FIG. 6 where only some features of the robotic painting machine are shown (and some of which are represented schematically) for clarity of illustration and where a first arrangement of pump system is illustrated.

FIG. 7B is another perspective view of the robotic painting machine like that in FIG. 7A except showing a second arrangement of the pump system.

FIG. 8 is a top plan view of a paint applicator of the robotic painting machine of FIG. 7 more clearly illustrating locations of distance sensors.

FIG. 9 is a side elevation view of the paint applicator of FIG. 8.

FIG. 10 is an elevation view of the robotic painting machine of FIG. 7A showing a transport or stored position of the machine and omitting some of the features for clarity of illustration.

FIG. 11 is a perspective view of a control unit housing of the automated paint application system.

FIG. 12 is a perspective view of a second embodiment of robotic painting machine according to the present invention as schematically depicted in FIG. 6 where only some of features of the robotic painting machine are shown (and some of which are represented schematically) for clarity of illustration and where the first arrangement of pump system is shown.

FIG. 13 is a perspective view of a multiple nozzle arrangement of the second embodiment of FIG. 12 where some components are schematically represented.

FIG. 14 is a schematic diagram of the multiple nozzle arrangement of FIG. 13 including a purging assembly and a nozzle selection assembly.

In the drawings like characters of reference indicate corresponding parts in the different figures.

### DETAILED DESCRIPTION

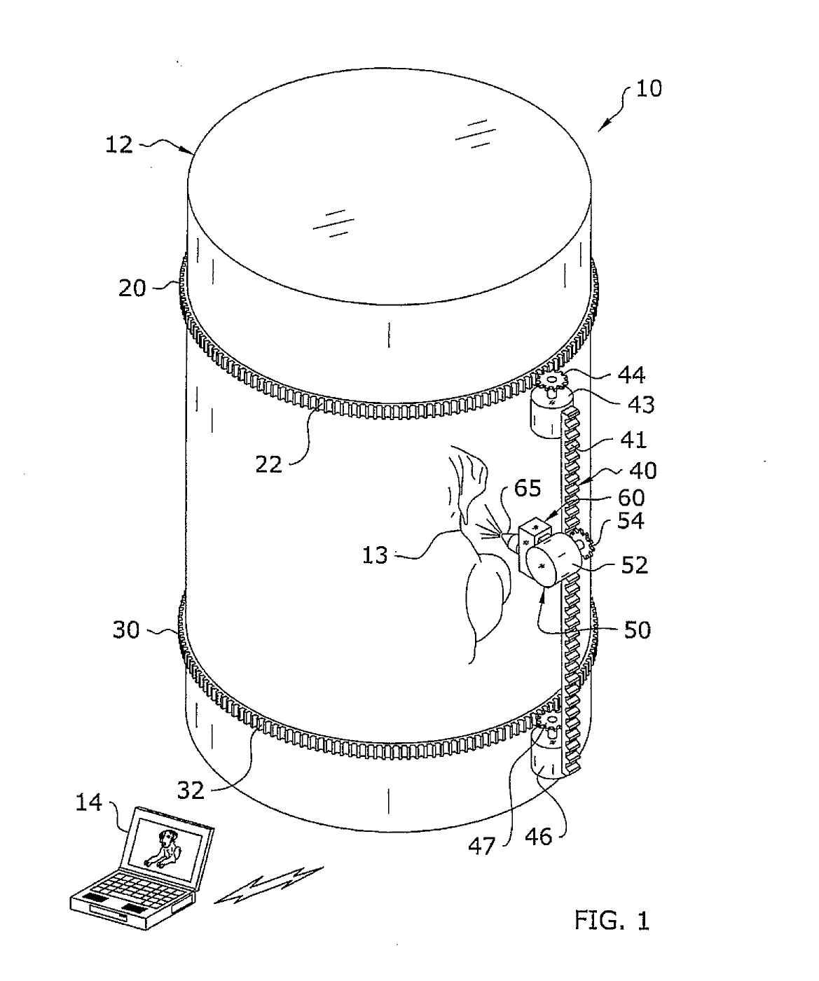

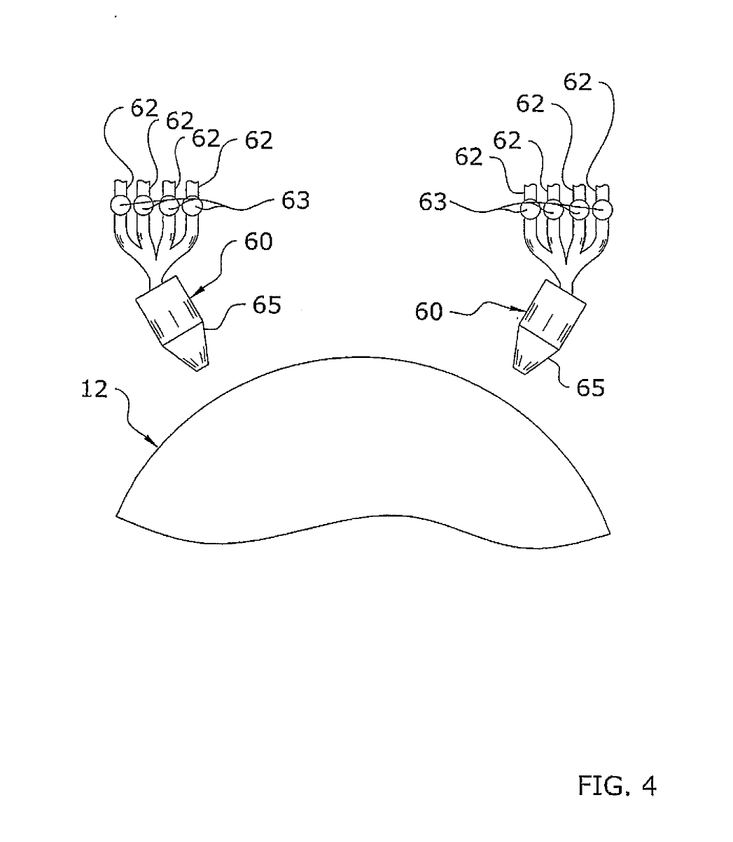

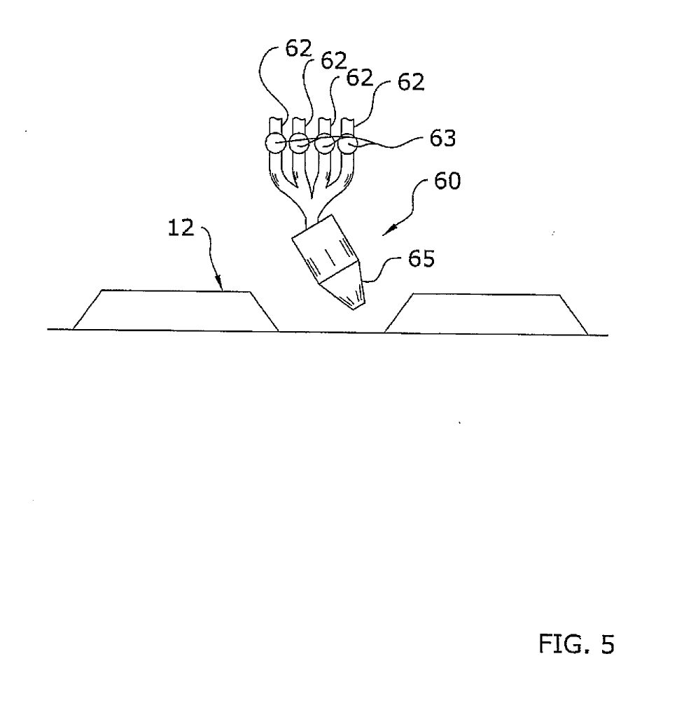

In FIGS. 1-5, there is illustrated a first arrangement of an automated paint application system 10, which comprises an first track 20 and a second track 30 which are secured to a structure in parallel relationship with each other. An applicator mount 40 is vertically secured between the first and second tracks 20, 30. Sprockets 44, 47 are utilized on the tracks 20, 30 to allow the applicator mount 40 to horizontally traverse the tracks 20, 30. A paint applicator 60 movably secured to the applicator mount 40 through use of an applicator sprocket 54 such that the paint applicator 60 may vertically traverse the applicator mount 40. A controller 14 may be provided to direct the automated paint application system to position itself and dispense paint in a manner which automatically paints an image 13 on the structure 12. The controller may be linked in a wired manner or wirelessly.

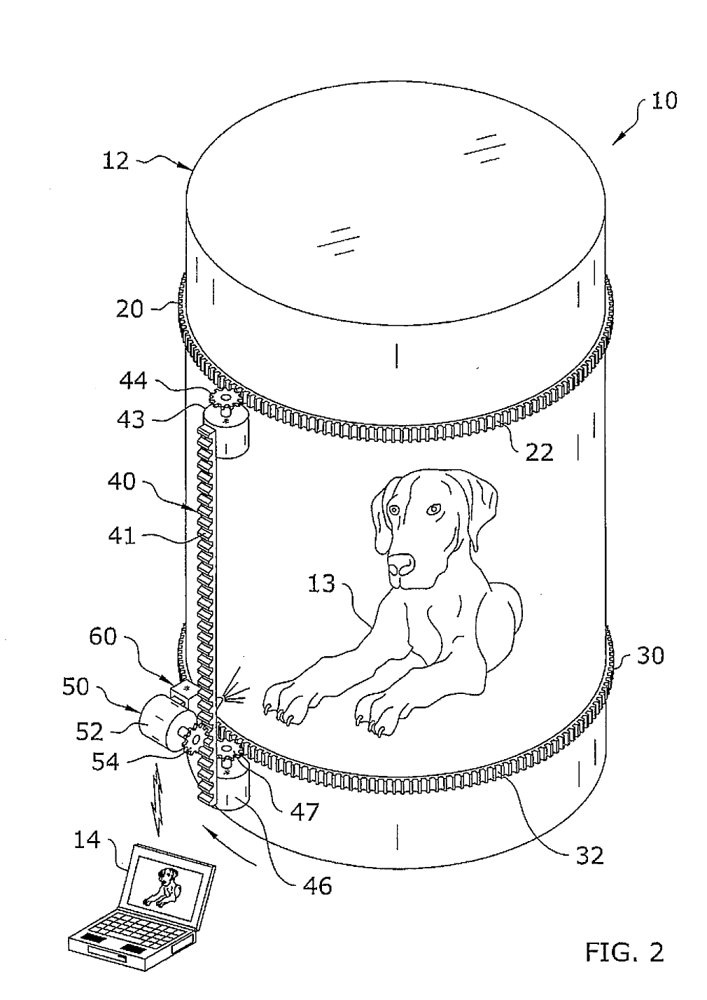

As shown in FIGS. 1 and 2, the automated paint application system utilizes a pair of tracks 20, 30 to support the applicator mount 40 and allow it to traverse over the structure 12 to be painted. Preferably, where the structure 12 being painted is upright, a first track 20 and a second track 30 will be utilized, wherein the first and second tracks 20, 30 are spaced-apart from each other and run parallel with respect to the other.

The first track 20 will generally be positioned at an upper end of the area of the structure 12 which is to be painted. The first track 20 may be secured to the structure 12 with various methods known in the arts, such as through usage of temporary fasteners or scaffolding structures. The second track 30 will generally be positioned at a lower end of the area of the structure 12 to be painted and similarly may be secured to the structure 12 with various methods known in the art. Preferably, both of the tracks 20, 30 will be removably secured to the structure so that they may be easily removed and transferred to storage or for use on a different structure.

It is appreciated that, in different arrangements for different applications, the first and second tracks 20, 30 may be positioned at various locations and in various orientations. While the figures illustrate exemplary arrangements utilizing an upper first track 20 and a lower second track 30, it is appreciated that the tracks 20, 30 may be positioned horizontally, diagonally or in any orientation so long as the applicator mount 40 may be positioned and moved there between for application of paints. In other arrangements, only a single track 20 may be utilized.

Various types of tracks 20, 30 may be utilized with the automated paint application system and the exemplary configuration shown in the figures should not be construed as limiting the scope of the automated paint application system. In one arrangement as better shown in FIGS. 1-2, the first track 20 will include a plurality of treads 22 running along its length. Similarly, the second track 30 will includes its own plurality of treads 32 running along its length. The treads 22, 32 are utilized to allow the sprockets 44, 47 of the applicator mount 40 to traverse the tracks 20, 30 when the automated paint application system is in use.

The automated paint application system includes an applicator mount 40 which is movably secured to both the first and second tracks 20, 30 as shown in FIGS. 1 and 2. The applicator mount 40 is generally comprised of a vertically-oriented track linked at its upper end to the first track 20 and at its lower end to the second track 30. The applicator mount 40 preferably includes its own treads 41 which are utilized to allow the applicator assembly 50 to traverse the applicator mount 40 and thus adjust vertically for painting.

The applicator mount 40 includes an upper motor 43 fixedly secured to its upper end as shown in the figures. The upper motor 43 may be comprised of various types of motors, such as electric or gas. An upper sprocket 44 is drivably secured to the upper motor 43 such that the motor 43 acts to rotate the upper sprocket 44. The upper sprocket 44 is secured to the first track 20 to aid with horizontally moving the applicator mount 40 across the structure 12.

The applicator mount 40 similarly includes a lower motor 46 fixedly secured to its lower end as shown in the figures. The lower motor 46 may be comprised of various types of motors, such as electric or gas. A lower sprocket 47 is drivably secured to the lower motor 46 such that the motor 46 acts to rotate the lower sprocket 47. The lower sprocket 47 is secured to the second track 30 to aid with horizontally moving the applicator mount 40 across the structure 12.

It is appreciated that the movement of the applicator mount 40 with respect to the tracks 20, 30 may be effectuated through various methods, such as by being belt-driven, rack and pinion driven, lead screw driven, hydraulically drive and the like.

The automated paint application system utilizes an applicator assembly 50 which traverses the applicator mount 40 vertically to apply paint to the structure 12 to create the image 13. The applicator assembly 50 is comprised of an applicator motor 52 and sprocket 54 which intermesh with the treads 41 of the applicator mount 40 to allow the applicator assembly 50 to traverse vertically.

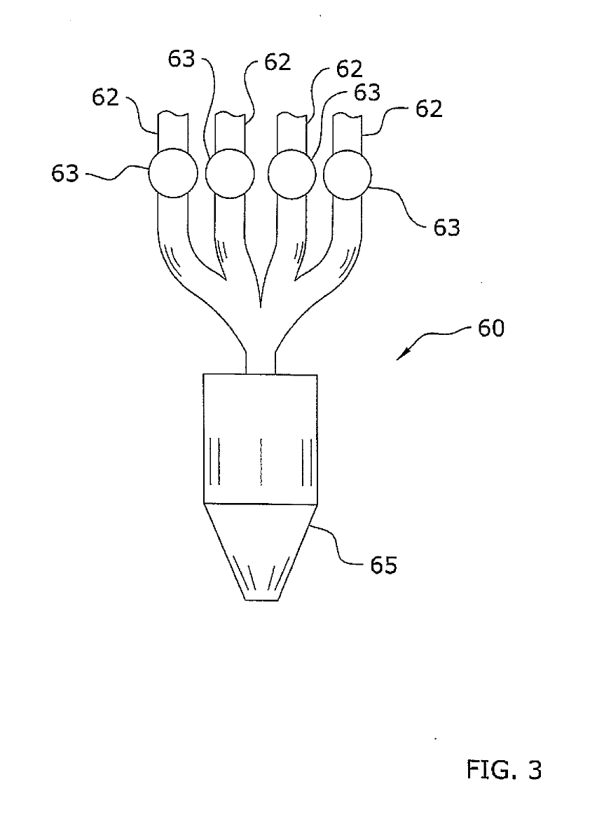

The applicator assembly 50 includes an attached paint applicator 60 which applies the paint to the structure 12 as described herein. The paint applicator 60, which is shown in detail in FIG. 3, generally includes a plurality of paint conduits 62 which converge into a single conduit prior to terminating into an applicator nozzle 65. Each of the paint conduits 62 includes a valve 63 to selectively allow paint to pass through when needed.

Preferably, each of the paint conduits 62 will be adapted to transfer a single color of paint. Thus, by selectively opening and/or closing the valves 63, different paint colors or combinations of colors may be applied to the structure 12 through the applicator nozzle 65. The control of the valves 63 will generally be controlled by a controller 14 adapted to control the various functionality of the automated paint application system as described below.

The paint applicator 60 may vary in form for different arrangements of the automated paint application system. Multiple variations of the paint applicator 60 may be utilized to vary the type of spray pattern being applied. For example, different paint applicators 60 may be utilized for large, round painted patterns than would be used with narrow, small patterns such as for trim. The paint applicator 60 may also be computer-controlled to spray anything from large round or flat patterns to small, fine patterns.

In use, the upper and second tracks 20, 30 are first secured to the structure 12 as shown in FIG. 1. The applicator mount 40 may then be secured between the upper and second tracks 20, 30, with the upper sprocket 44 movably secured to the treads 22 of the first track 20 and the lower sprocket 47 movably secured to the treads 32 of the second track 30. Thus, the applicator mount 40 will be adapted to horizontally traverse the upper and second tracks 20, 30.

The applicator assembly 50 may then be secured to the applicator mount 40, with the applicator sprocket 54 movably secured to the treads 41 of the applicator mount 40 such that the applicator assembly 50 may vertically traverse the applicator mount 40.

The overall operation of the automated paint application system will be directed by a controller 14, such as a laptop, personal computer or tablet. The controller 14 may be connected to the automated paint application system via wires or a wireless connection as shown in the figures. The controller 14 will receive the image 13 to be painted on the structure 12 and then automatically direct movement of the applicator mount 40 and applicator assembly 50 to proper positioning for painting. The controller 14 will also control the valves 63 of the paint applicator 60 to properly dispense the paint colors needed to complete the image 13.

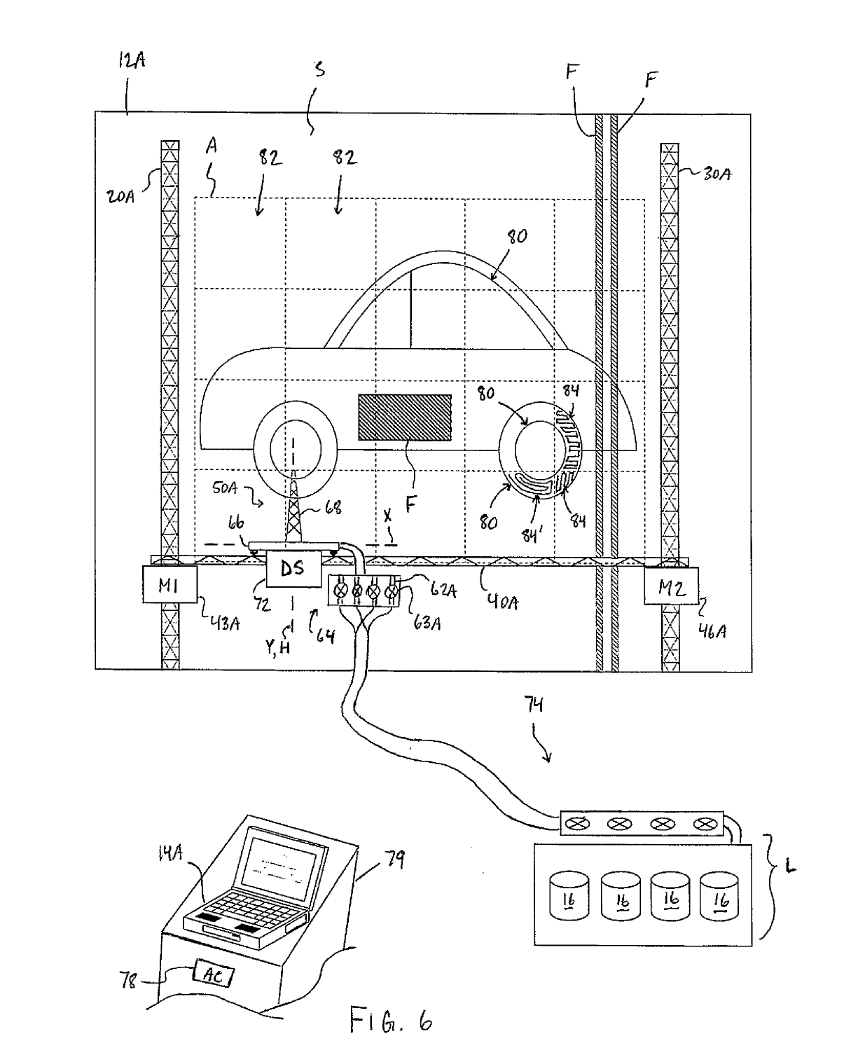

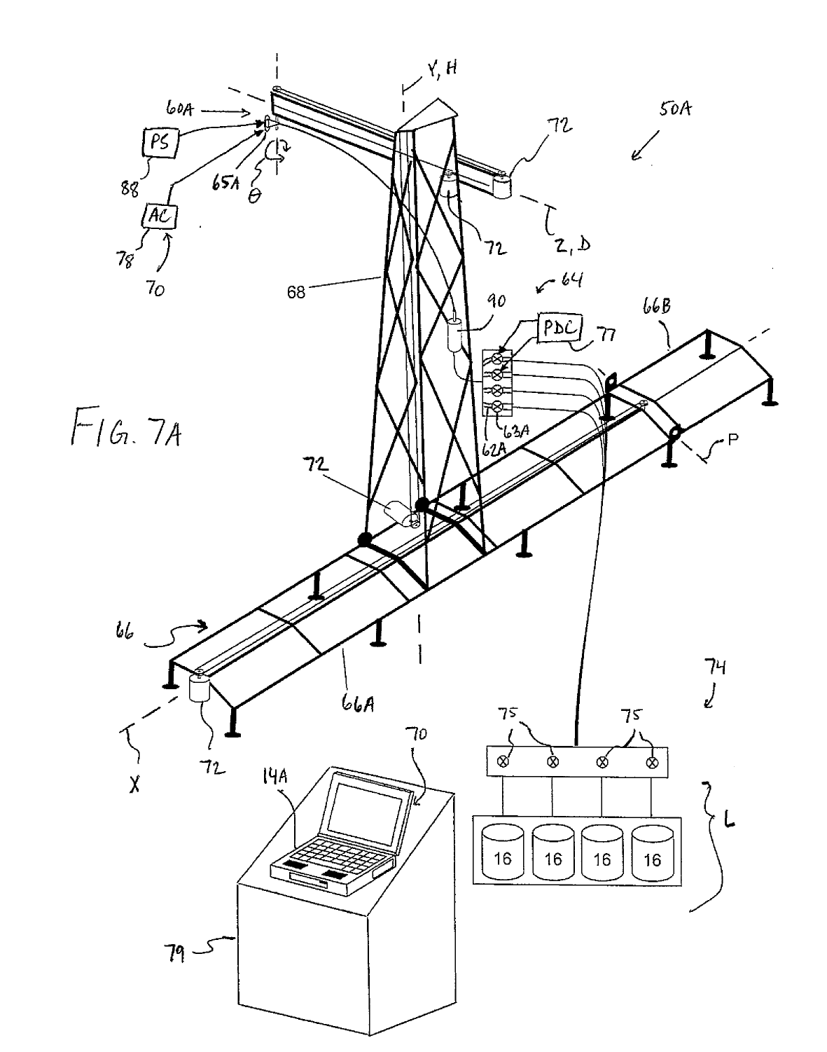

Returning to the tracks in more detail, the tracks are removably secured to a surface ‘S’ of the structure so as to extend along the surface in fixed position relative thereto. In a second illustrated arrangement of the tracks 20A and 30A as shown in FIGS. 6-7, the tracks are suited for fastening to a surface which is planar as opposed to a rounded surface as shown in FIGS. 1-2. Furthermore, as in the first illustrated arrangement better seen in FIGS. 1 and 2, the tracks are removably secured to the surface using conventional fastening arrangements.

The tracks delimit an area ‘A’ of the surface S of the structure on which the image 13 may be painted, or in other words a painting area A of the surface. In instances where a size of the image 13 exceeds a maximum spacing of the tracks, which may, for example, be limited by a length of the applicator mount 40 or 40A, the tracks may be moved so as to delimit another area of the surface to be painted once a first portion of the image is reproduced on the surface. As such, a painting area A is delimited in each fixed position of the tracks. Thus, depending on factors such as the size of the image or a shape of the structure (for example, an image is to be painted over two adjoining walls which meet at a corner), the tracks may be moved along the surface S so that the painting area A delimited by the tracks in each fixed position relative to the structure may comprise one of a plurality of portions of the image or an entirety of the image.

The applicator mount 40A extends between the tracks 20A, 30A which are in spaced parallel relation to one another. In the illustrated arrangements, the applicator mount is elongate in a respective longitudinal axis thereof so as to span between the tracks. The applicator mount is movably coupled to the tracks by conventional cooperating mechanisms for achieving controlled movement such as cooperating wheels with sprockets and treads. Thus, the operative movable coupling between the applicator mount and the tracks is not discussed in detail herein.

In other terms, the applicator assembly may be referred to as a robotic painting machine. The robotic painting machine, as indicated in the second illustrated arrangements at 50A and 50A′, is defined at least in part by a paint applicator 60A comprising a painting arm 61 which carries an applicator nozzle 65A thereon; a base 66 which is elongate in a longitudinal axis along the surface S and which is carried on the applicator mount 40A for movement along the longitudinal axis of the applicator mount; an support boom 68 carried on the base 66 that supports the paint applicator; and a control system 70 actively directing the applicator nozzle 65A about the surface S which exists in an uncontrolled environment. In such an uncontrolled environment, it may not be possible to map the surface accurately and/or fully ahead of time. Alternatively or additionally, ambient conditions and obstacles which may obstruct or impede the motion of the robotic painting machine may change over the course of the painting process unlike in a controlled environment such as a paint booth which is generally closed to the external environment and the ambient conditions of the paint booth maintained.

Note that we initially turn our attention to a first embodiment 50A of the robotic painting machine of the arrangement referenced in the previous paragraph. Later, a second embodiment 50A′ of the arrangement of robotic painting machine, which is referenced in the previous paragraph, is discussed in more detail and particularly in regards to its differences from the first embodiment 50A. Thus, we commence with further detail on the first embodiment below.

According to the above structure, the applicator nozzle 65A of the paint applicator 60A, which sprays the paint onto the surface S in a spraying mode of the applicator nozzle, is arranged for motion in four axes: (I) an X-axis of travel along the longitudinal axis of the elongate base that is indicated at ‘X’, which in the second illustrated arrangement is oriented generally parallel to the surface S being painted along the longitudinal axis of the applicator mount 60A; (ii) a Y-axis of travel indicated at ‘Y’ that is along a transverse axis perpendicular to and upstanding from the elongate base 66, which in the illustrated embodiment is oriented generally parallel to the surface S being painted along the longitudinal axis of the tracks; (iii) a Z-axis of travel indicated at ‘Z’ that is perpendicular to the X- and Y-axes of travel so as to typically be normal to the surface S being painted; and (iv) a Theta-axis of travel indicated at ‘A’ which comprises angular rotation relative to the Y-axis but occurring about a separate axis located at a position of the applicator nozzle 65A along the painting arm 61. Thus, the applicator nozzle 65A is pivotally carried on the painting arm 61 of the paint applicator so as to be movable in the Theta-axis of travel. More particularly, the X-axis of travel is afforded by movement of the support boom 68 along the elongate base 66 in the longitudinal axis thereof. The Y-axis of travel is afforded by movement of the paint applicator 60A along a longitudinal axis of the support boom and thus across a height axis ‘H’ of the support boom that is transverse to the longitudinal axis of the base; the support boom 68 is elongate and upstanding on the base 66. The Z-axis of travel is afforded by movement of the painting arm 61 in a depth axis ‘D’ oriented perpendicularly to the height axis H of the support boom and to the longitudinal axis of the base. The Theta-axis of travel is afforded by rotational movement of the applicator nozzle 65A relative to the painting arm 61 so as to provide the applicator nozzle with movement like that of the human wrist. The Theta-axis of travel is provided by a servo motor (not shown) supported on the painting arm 61 that drives rotation of the servo motor's shaft to which the applicator nozzle is attached. Each of the parts of the robotic painting machine are coupled to one another according to arrangements known in the art of robotics and are thus not described in detail herein. Furthermore, a plurality of drive motors are provided for driving the motion of the applicator nozzle 65A at and about the surface S of the structure, and these drive motors define a drive system of the robotic painting machine shown schematically at 72 that is operatively coupled, such as by cooperating belt or chain and pulleys, to at least all of the support boom 68, the paint applicator 60A, the painting arm 61, and the applicator nozzle 65A for driving movement thereof. The base 66 also comprises drive motors (not shown) for movement along the applicator mount, which may be considered a portion of the drive system of the robotic painting machine referred to hereinbefore. The drive motors primarily comprise servo motors, typically used in automated systems, which are capable of operating using control feedback for the control system 70 to ensure correct movement of the robotic painting machine. The drive system 72 of the robotic painting machine communicates with the motors 43A, 46A of the applicator mount on the tracks 20A, 30A so that the robotic painting machine is able to traverse the entirety of the painting area A.

Collectively, the various axes of travel, especially the X- and Y- and Z-axes, allow the applicator nozzle 65A to traverse the surface S of the structure 12A and the Theta-axis allows aim of the applicator nozzle towards to the surface S to be maintained substantially normal thereto. Furthermore, the Z- and Theta-axes in particular afford an ability to manoeuver the applicator nozzle 65A out of the path of surface features generally indicated at ‘F’ to avoid collision therewith. The surface features F may include projections or protrusions such as from a flat or rounded wall, miscellaneous objects in proximity to the surface such as electrical wires lying along or adjacent the surface, and miscellaneous objects disposed in the surface such as windows and doors. Moreover, adjustment of the applicator nozzle 65A in the Z- and Theta-axes provides consistent paint delivery to the surface in a manner which accurately reproduces the image.

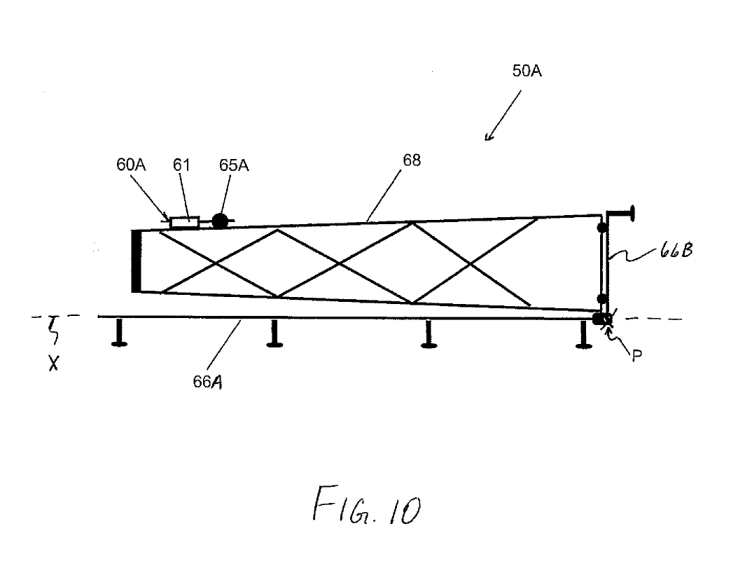

Additionally, the base 66 comprises a main base portion 66A and an end base portion 66B. The end base portion 66B is shorter in length than the main portion and is pivotally coupled to the main portion, such as by hinges, at one longitudinal end thereof. Thus, the end portion 66B is pivotally movable relative to the main portion 66A about pivot axis P thereby affording movement of the end base portion between a first aligned position, as shown for example in FIG. 7A or 7B, and a second folded position, as given in FIG. 10. In the first aligned position, the end base portion is aligned with the main base portion along the longitudinal axis of the base such that the support boom 68 may move in its upstanding position along the base 66. Note that in the upstanding position of the support boom, the height axis H of the support boom is transverse to the longitudinal axis of the base 66. In the second folded position, the end base portion 66B is folded relative to the main base portion 66A so as to be oriented transversely to the main base portion and thus located outside of the longitudinal axis of the base. Thus, the support boom 68 may be laid generally parallel to the main base portion 66A in a transport or stored position of the support boom when the support boom is moved to the end base portion 66B and the end base portion is then moved into the second folded position. Note that in the transport or stored position, the height axis H is parallel to the longitudinal axis of the base. Positioning of the end portion 66B in the second folded position is also suited for reducing an overall length of the base 66 as measured along its longitudinal axis.

Fasteners such as pins inserted through apertures cooperatively maintain the end base portion 66B and main base portion 66A in alignment along the base's longitudinal axis in the first aligned position (omitted from illustration for clarity as this is a conventional locking arrangement). The fasteners are removed so that the end portion 66B may be moved into the second folded position.

Thus, the robotic painting machine 50A is foldable so as to be more easily transported from one location to another or from one area of the surface S to another to continue painting the image.

The robotic painting machine 50A is constructed from lightweight metal such as lightweight aluminum which allows the machine to be transportable by hand, supportable by crane or forklift, and supported by the tracks and the applicator mount while reducing stress on these components that is due to the weight of the robotic painting machine. Moreover, the machine 50A comprises a narrow profile (in end-view) so that the machine 50A is suited to be manoeuvered into relatively tight spaces for painting.

The robotic painting machine also includes a pump system 74 for transferring the different colours of paint through the paint conduits shown schematically at 62A which define a hue or colour mixing system. As described earlier, the paints are mixed at a location close to or at the applicator nozzle 65A such as in the single conduit joining the plurality of paint conduits 62A to the applicator nozzle. In the illustrated arrangements, the paint 16 is stored within a few hundred feet of the robotic painting machine 50A, so the pump system 74 is suited for transferring the different coloured paints across such distances to the robotic painting machine which is located at the surface S.

In the illustrated arrangement as more clearly shown in FIG. 7A, the pump system includes a set of transfer pumps 75 (schematically shown) which comprise servo controlled gear pumps or positive displacement pumps (PDPs), such as progressive cavity pumps (PCPs), which are suited for delivering the paints. The transfer pumps 75 are operatively coupled, such as by flexible tubing or hoses and valves as required, to paint containers such as conventional paint pots storing the paints at a supply location ‘L’ (schematically shown) located at a distance from the robotic painting machine. One transfer pump regulates flow of a single paint colour stored at the supply location L and transfers a proper portion of the respective coloured paint. As part of controlling the proper proportions, a volumetric amount of each paint colour which is transferred may be determined at least in part by tracking a number of rotations of the respective transfer pump 75 since, by nature of the type of pump, each rotation thereof transfers a known and generally constant amount of paint.

The transfer pumps 75 comprising the positive displacement pumps are conventional units and thus not described in detail herein; however, notably, the PDPs which are selected and implemented in the illustrated arrangement have zero “slip” or internal leakage of material up to 350 pounds per square inch of pressure (selected accordingly based on viscosity of the paints being pumped) thereby providing a known and repeatable, and therefore precise, flow rate from each pump. Such precise pumping is suited for transferring a sufficient amount of paint to the applicator nozzle that is required for painting. Note that zero internal leakage of material may also be provided up to a pressure value of 335 pounds per square inch and the system will function similarly well. Furthermore, zero internal leakage of material up to a pressure value of 325 pounds per square inch may be provided and the system will function similarly well.

The transfer pumps 75 are driven by servo motors (not shown) sized accordingly to the pump which each motor powers so as to provide, for example, sufficient torque for starting the respective transfer pump. As known in the art, the servo motors provide feedback communicated to the control system which may provide functionality to precisely setup the system for use. Furthermore, the transfer pumps 75 employ electronic gearing relative to a ‘virtual’ master pump so as to provide the proper proportion of coloured paints for mixing proper ratios thereof. That is, each transfer pump is arranged to displace an amount of paint with respect to a normalized base value. In this manner, amounts displaced by each transfer pump remain consistent and are synchronized relative to the base value which is constant.

As shown in another arrangement which is illustrated in FIG. 7B, the transfer pumps indicated at 75 may be substituted for a pressurizing assembly 76A to deliver the paint from the paint containers to the colour mixing system. The pressurizing assembly 76A, located at the supply location L, is connected to each one of the paint containers and provides a gas such as air into each one of the paint containers so as to pressurize the respective paint container thereby generating a constant and known transfer pressure at the supply location L. For example, the pressurizing assembly 76A includes at least one conventional air pressure pump operatively connected to the paint containers by suitable hoses or tubing; as such, the pressurizing assembly is of a conventional type which is known in the art and thus not described further herein. A first set of valves indicated at 76B connects the paint containers to the paint conduits 62A.

Referring back to the paint conduits, it will be appreciated that the paint conduits 62A and/or the single conduit into which the plurality of paint conduits converge may be regarded as respectively defining a paint delivery system 64 that is connected to the applicator nozzle for transferring the paint thereto.

As mentioned hereinbefore, the paint delivery system 64 comprising the paint conduits, each of which is connected by a conduit valve 63A to the applicator nozzle, are usable for respectively transferring a different coloured paint. A paint delivery controller 77 within the control system 70 is connected, by wires or wirelessly, to the valves to selectively control their operation for dispensing the paint that is transferred by the respective paint conduit. The paint delivery controller 77 is operable in a first direct mode such that one of the different coloured paints is selectable and passed through to the applicator nozzle and in a second mixing mode such that a combination colour is formed including in combination two or more of the paints from the paint conduits. With the PDPs delivering the paint to the robotic painting machine 50A, precise amounts of at least two of basic colours each carried by the respective paint conduits may be able to be mixed together to form the correct hue needed for the image for application to the surface S.

Furthermore, the conduit valves 63A comprise precision valves, such as needle valves. The precision valves may be utilized to provide the proper proportion of each different coloured paint for mixing at the mixing system. As an example, in the arrangement comprising the pressuring assembly 76A as more clearly shown in FIG. 7B, the proper proportions may be provided by controlling a duration of time for which the respective precision valve 63A is open and a throttle position thereof (for example, half-open or full-open) as the respective coloured paint is passed through the paint conduit at the known transfer pressure. Thus the combination colour may be formed.

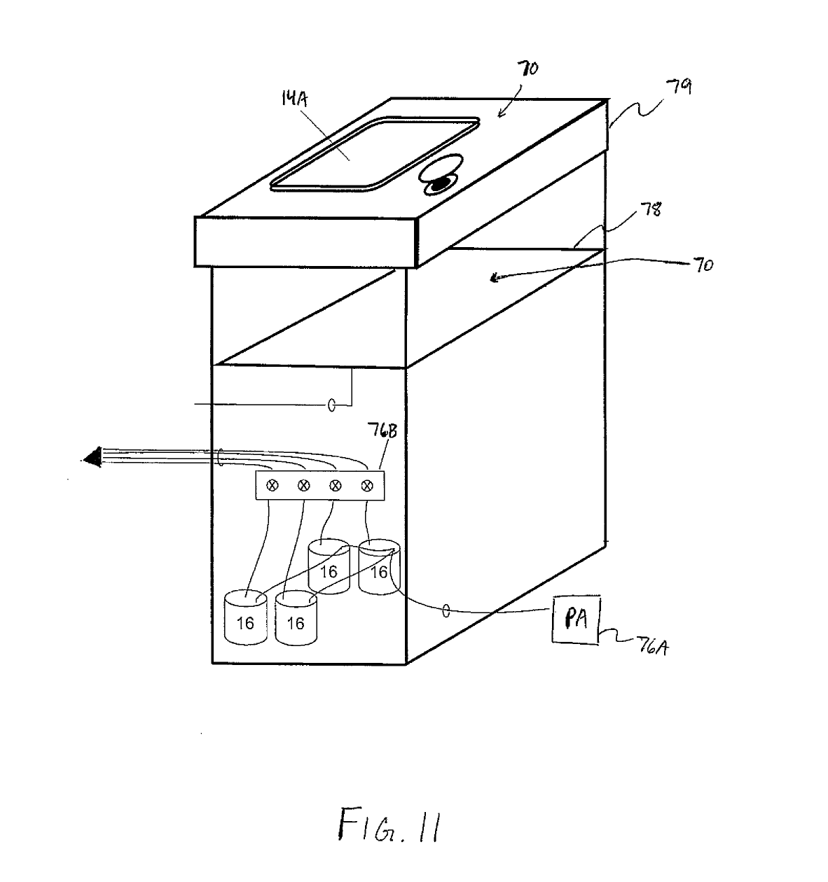

In addition to the aforementioned painting hardware of the robotic painting machine 50A, the control system 70 manages the painting process and directs the machine 50A. The control system comprises an applicator controller 78 (schematically shown) which is contained in a control unit housing 79 located at a distance from the robotic painting machine; software; sensors which are positioned to provide data for operation; and the remote controller indicated at 14A that is handled by the user thus providing a user interface with the robotic painting machine 50A. The remote controller and applicator controller are linked by wires or wirelessly so as to be communicable with one another. Also, the applicator controller is linked to the components disposed on or at the robotic painting machine by wires or wirelessly. In other arrangements, the applicator controller may reside on the robotic painting machine. Furthermore, the supply location L of the paint 16 may coincide with location of the control unit housing 79 such that the paint is stored inside the control unit housing, as more clearly shown in FIG. 11. Moreover, the control system 70 is also connected to the pump system 74 and the conduit valves 63A in the paint conduits for selectively controlling operation in the first direct mode and the second mixing mode. Thus, the control system comprises a network of components which collectively direct the robotic painting machine in performing its tasks including spraying of paint 16, collision avoidance with the surface features F, and movement about the surface S.

Now, we turn our attention to the painting process which is discussed in more detail in the following paragraphs.

Initially, the image is provided to the control system, specifically to the remote controller 14A, in a format that is storable on a computing device having memory like a conventional personal computer. Most typically, it is expected that the image would be provided in a conventional bit-mapped format such as BMP, JPEG, TIFF, PNG, or DXF, although the image may be alternatively provided in a vectorized format or another format. Furthermore, the image is typically provided in full colour as there are no limitations to colour processing abilities of the control system—the control system is able to handle colour, black and white, and grayscale images, to provide a few examples. It will be understood that black and white and grayscale images may also be provided to the control system, in which case the image will be reproduced on the surface S in black and white or grayscale, accordingly.

In preparation of the image for reproduction on the surface S, the image is converted to a vectorized format from the initial format in which the image was initially stored. In the illustrated arrangement, the conversion is performed by the remote controller 14A. Note that ‘vectorized format’ is used as commonly understood in the graphics industry.

Conversion from the initial format to the vectorized format usable by the automated paint application system is performed by software using vectorization (also known as image tracing) algorithms.

Manipulation and management of the image in the vectorized format includes several benefits. For one, the vector image can be infinitely resized without degradation in resolution or image quality.

Also, the paint applicator 50A may be capable of reproducing the image on the surface in continuous motion of the paint applicator. The continuous motion includes movement of the paint applicator in the X- and Y-axes and movement of the applicator nozzle in the Z- and Theta-axes. The continuous motion and resulting painting process may, in at least a few ways, be considered as that of a human hand. A nozzle pressure of the applicator nozzle may also be dynamically adjusted according to a speed of the motion of the applicator nozzle 65A in all axes so that a density of the applied paint may be properly regulated for accurate and precise reproduction of the image. Thus, the robotic painting machine may be markedly faster than a manual painter and prior art machines for painting large surfaces. For example, the robotic painting machine may be capable of spraying paint to cover a portion of the area A at a rate of 36 square inches per second.

Additionally, active management of the surface features F which are not initially accounted for when the robotic painting machine begins spraying the paint may be possible. Management in a manner so as to avoid collision with such surface features and to accommodate them in reproduction of the image. Such accommodation of the surface features may include repositioning of the applicator nozzle in at least one of the Z- and Theta-axes so as to properly apply the paint to the surface. Also, the painting process may be interruptible at any moment during same in that the machine follows continuous paint paths which are not broken into discrete points or locations on the surface. Thus, the painting process may be interrupted for purposes such as cleaning of the machine or other equipment, refilling the paint stored at the distance from the robotic painting machine, or removing obstructions from the path of the robotic painting machine. Similarly, the painting process may be resumable at any location within the image. Furthermore, the paint paths may be followed in a reverse direction so as to overlap a portion of the respective paint path already traced. The vectorized format may realize other benefits which will become apparent hereinafter.

Returning to description of the image, the image contains or has one or more constituent hues each which has at least one shade and at least one level of saturation. The image may also have shadowing that results from a reduction of light cast upon a particular portion of the image, as rendered within the image by the artist. As such, shadowing is intended to be included within the scope of at least one of the shade and saturation level of the constituent hue. (Typically, shadowing is considered to be a shading-based concept.)

A software program installed on the remote controller 14A is used to separate the image into its plurality of constituent hues so that each constituent hue can be regarded separately of the other by the system. For example, a conventional, off-the-shelf program is suited for performing colour separation. Each constituent hue may, as such, include one or more shades so that each shade is mapped within the constituent hue. The constituent hues and their shades may be categorized, or in other words characterized, using a standardized colour system (e.g., Pantone colour system).

The software of the control system processes each constituent hue into an individual layer 80 of the image. For example, in the image of a car as illustrated in FIG. 6 the tires, wheel rims, car body, and windows respectively comprise separate image layers. Each image layer 80 is applied to the surface successively one at a time. That is, one image layer is applied prior to application of another one of the image layers. Also, as alluded to in the previous paragraph, the shades of the constituent hue defining the respective image layer are mapped within the image layer 80.

The software of the control system also calculates a volumetric amount of paint needed for the image based on the size of the image, paint shading (since darker shades require more paint), paint shadowing, and other details of the image. The software also accounts for factors such as surface type; temperature of the paint; ambient temperature of an external environment surrounding the surface S and the robotic painting machine 50A; a speed at which the motion of the applicator nozzle is set, such as by the user, to move about the surface; and the pressure at the applicator nozzle.

Depending upon the available hues of the paint 16, the constituent hue for the image may be prepared manually so that the constituent hue is ready fed by one of the pump system to the paint delivery system and thus the respective paint conduit of the applicator nozzle. Alternatively, the required starting or basic hues, from which the desired constituent hue can be made if a unique combination thereof, can be supplied through the paint conduits for mixing at the mixing system of the robotic painting machine. In this second scenario of mixing different coloured paints to form the desired constituent hue, the basic hues are respectively dispensed through the paint conduits by control of the valves and mixed and held in a small holding vessel defined by the single conduit into which the plurality of paint conduits converge prior to connecting to the applicator nozzle 65A. This combination colour is then ready to be applied to the painting surface S at a prescribed pressure in order to generate the shade at that particular surface location of the applicator nozzle.

The control system 70 also resizes the image according to the area A of the surface on which the image is to be applied. As mentioned hereinbefore, the area may comprise a portion of the surface or the entire surface. The area may also bridge a corner between two adjoining walls. The tracks may be repositioned to locate the robotic painting machine at each portion of the area to be painted. This resizing is possible using conventional, off-the-shelf software and algorithms because of the vectorized format of the image.

Preparation of the image for reproduction also includes a step of dividing the image into a plurality of image sections 82 on the area A of the surface on which the image is to be applied. For example, the image may be divided into a grid forming rectangular tiles (e.g., square tiles) on the area A of the surface as more clearly illustrated in FIG. 6. That is, the image sections 82 organize the image into smaller portions of the area A at which the robotic painting machine 50A can work to paint for efficiency and precision of painting. Each image section 82 is applied one at a time. The image sections 82 may be sized according to the paint coverage area of the paint applicator in a stationary position of the base 66 at the surface S. That is, the stationary position of the base is that when the base is static relative to the applicator mount and the applicator mount is stationary relative to the tracks so that the paint coverage area is measured by a painting area which can be painted by the applicator nozzle with motion primarily in the X- and Y-axes. Thus, the paint coverage area is defined primarily by a maximum range of movement of the support boom 68 along the longitudinal axis (collinear with the X-axis) of the base 66 and a maximum range of movement of the paint applicator 50A across the height axis H of the support boom. Alternatively or additionally, the image sections 82 may be sized such that movement of the robotic painting machine from a first position at one image section to a second position at an adjacent image section is minimized. That is, the movement of the robotic painting machine 50A which is sought to be minimized includes a number of instances of relocating the robotic painting machine along the applicator mount in completing a row of image sections 82 and a number of instances of relocating the applicator mount across the tracks in order to complete the image.

Using software on the remote controller 14A, the vectorized image, which is divided into the plurality of image layers 80 and organized into the plurality of image sections 82, is transformed or converted into motion control code for instructing motion of the paint applicator 60A and communicated from the remote controller 14A to the applicator controller 78 on the robotic painting machine. That is, the motion control code comprising one or more paint paths 84, which collectively form the image, is uniquely generated for the image with the vectorized format thereof. Note that the specific number of paint paths depends on the size and intricacy of the image. Each paint path 84 contains or has one of the constituent hues of the image and follows its own spatial path about the surface S that is typically unique compared to that of the other paint paths. The paint paths 84 are usable by the control system 70 in a manner so that the paint paths are followable or traceable on the painting surface S by the robotic painting machine 50A in continuous motion thereof. However, as mentioned earlier, the painting process that comprises following one of the paint paths may be interrupted if deemed necessary by the user. The paint paths are typically localized to each image section 82 such that one or more paint paths may form a single image layer 80 as, for example, in the instance that the single image layer extends across a plurality of image sections 82.

The spatial path of the respective paint path may comprise initially tracing an outline or contour of a working portion of the image layer 80 which resides in the image section 82 at which the robotic painting machine is working, followed by progressively filling in the working portion of the image layer by traversing along the contour until completely filled-in. Thus, the paint path resembles a spiral pattern started from an outwardly point and terminating at an inwardly-most point.

In other words, the paint path may comprise forming an outline of the first layer and colouring inwardly from the outer outline thereof to an inner point of the respective image layer that is enclosed by the outline so as to fill in the layer. FIG. 6 more clearly illustrates at 84′ an example of how such a paint path may look as described in this paragraph and the previous paragraph.

Alternatively, the spatial path of the respective paint path may comprise traversing side-to-side within boundaries of the working portion of the image layer so as to progressively paint the working portion of this layer starting from one side and moving across towards the other side. Such side-to-side movement may comprise left-and-right motion such that paint path portions are generally parallel to the X-axis of travel with shifting or jogging of the applicator nozzle in a direction parallel to the Y-axis of travel, or up-and-down motion such that the paint path portions are generally parallel to the Y-axis of travel with jogging of the applicator nozzle in a direction parallel to the X-axis of travel. This side-to-side movement only occurs within the boundaries or the outline of the working portion of the respective image layer such that the paint path portions may vary in length as the applicator progresses from one end of the working portion of the image layer to the other within the image section. Also, the outline of the working portion of the image layer may be painted first prior to using the side-to-side movement to fill in the working portion enclosed by the outline. Alternatively, the outline of the working portion may be painted after using the side-to-side movement so as to paint any edges of the working portion which were not applied or which may not be applicable by the applicator nozzle in the side-to-side movement. FIG. 6 more clearly illustrates, within the right-hand-most image sections enclosing portions of a rear wheel of the car, how such paint paths may look as described in this paragraph.

Once the image has been processed and prepared for application to the area A of the surface, the robotic painting machine 50A may begin applying the paint to the surface.

Note that the remote controller 14A that defines the user interface serves as a recipe handler (as understood by a person skilled in the art of computer programming) for managing creation of the motion control code and code for handling the paints having to be applied to achieve the constituent hues of the image.

The remote controller 14A, which is linked to the applicator controller by wires or wirelessly such as by Ethernet connection so as to be communicable therewith, exports a batch-type file to the applicator controller 78 that has respective files for motion control and paint handling (i.e., the constituent hues to be applied for working portions at each image section and shading information). Each file for the motion control and paint handling comprises multiple layers which correspond to the various constituent hues of the image. The batch-type file, once sent to the applicator controller, is stored on the applicator controller's memory.

Prior to executing the painting process, the robotic painting machine 50A may perform a calibration sequence which is, in other words, a preparatory step of scanning the surface S to be painted in first and second dimensions collectively defining a scanning plane which is substantially parallel to the surface S. That is, for example, the scanning plane may be arranged parallel to a flat surface or a corrugated planar wall, or may be arranged parallel to a tangent of a rounded surface such as the wall of the water tower of FIGS. 1-2. The first and second dimensions correspond to the X- and Y-axes of travel of the robotic painting machine. Additionally, the scanning step includes scanning in a third dimension which is normal to the surface S, and this third dimension corresponds to the Z-axis of travel and the depth axis D. The surface is scanned using distance sensors 86, which are disposed on the robotic painting machine in proximity to a head of the machine which is defined by the applicator nozzle 65A, to detect the surface features F as the robotic painting machine is displaced in controlled movement about the surface S in the scanning plane. Thus, the scanning step provides a map of the surface features in the first, second, and third dimensions. The map is also similar to a contour relief map, like in 3D digitizing, with information on the depth of the surface relative to the applicator nozzle. The depth of the surface S in the map as measured in the third dimension, which corresponds to the Z-axis, is measured with respect to a pre-specified distance at which the applicator nozzle 65A is to be maintained from the surface S that is, in the illustrated arrangements, entered by the user. Performing the scanning step may afford quicker and/or more efficient painting in that the painting machine ‘knows’ the surface S to be painted and can thus plan its paint paths 84 accordingly including taking the surface features F into account in advance.

With the instructions loaded on the applicator controller 78, the painting process of the robotic painting machine 50A is initialized by providing a datum or fixed starting point in terms of the X-, Y-, Z-, and Theta axes of travel, after which the robotic painting machine may begin executing the painting process. The starting point is set to one of a plurality of limits of the travel of the robotic painting machine that are defined by limit switches which are fitted to the robotic painting machine and the tracks (when the tracks are used). Also, the user adjusts the robotic painting machine's position at the surface to match that of the starting point, such as by physically or manually adjusting the robotic painting machine's axes and moving the applicator mount along the tracks. Typically, the starting point is at the bottom left-hand corner of the painting area of the surface, which is analogous to a Cartesian origin or (0, 0) point of the image in the X- and Y-axes.

Once the starting position is properly set, the robotic painting machine begins applying the paint to the surface S, progressing through each image layer 80 at the respective image section 82 one at a time. That is, all of the image layers at one image section are applied prior to working on and thereby reproducing the next image section. The robotic painting machine progresses through each image layer 80 one at a time, and this may be done automatically or subject to user selection of the respective layer. Conventionally, regardless of automatic or manual progression through the layers, a white backing layer is applied first and is followed by each constituent hue at the respective image section 82 from light to dark.

The applicator controller 78 then controls the drive motors of the drive system for movement of the robotic painting machine. As mentioned hereinbefore, the drive motors comprise servo motors which have positional feedback capabilities provided by encoders or resolvers that are known in the art.

By means of the tracks 20A and 30A, applicator mount 40A, and the base 66 of the robotic painting machine, the applicator nozzle 65A of the paint applicator 60A is located at a first one of the image sections 82 to be painted. The base 66 remains in the stationary position while the applicator nozzle of the paint applicator traverses the area of the image section 82 and applies the paint to the surface S one image layer at a time.

As discussed hereinbefore, the constituent hue to be applied may be prepared by mixing two or more of the basic hues of paint at the colour mixing system of the robotic painting machine. Prior to the mixing, a sufficient volumetric amount of paint for the constituent hue is calculated based on the paint path that has to be covered by applying the paint in this particular hue. The calculation allows a precise amount of each basic hue, from which the constituent hue is derived, to be transferred by the pump system 74 from the supply location L of the paint 16 to the colour mixing system which is located at the surface S, at a distance from the supply location L.

For maintaining a consistent prescribed density of paint for the respective constituent hue, the robotic painting machine is arranged such that the distance sensors 86 provide distance information to the software so that the applicator nozzle of the paint applicator is maintained at a safe distance from the surface S to avoid collision and at the pre-specified correct distance for the prescribed density of paint that is required. The prescribed density of paint corresponds to a reference shade of the constituent hue.

The distance sensors 86 (schematically shown) are located on the painting arm 61 at strategic locations at or adjacent a distal end of the painting arm so as to be near the applicator nozzle 65A for detecting obstacles, such as those defined by the surface features F, in the path of motion of the applicator nozzle. In particular, the strategic locations include first and second locations facing in each direction along the longitudinal axis of the base 66 which is also along the X-axis of travel of the robotic painting machine. Furthermore, respective ones of the distance sensors are located at third and fourth locations facing in each direction along the height axis H of the support boom 68 which is also along the Y-axis of travel of the robotic painting machine. Additionally, a respective one of the distance sensors is located at a fifth location facing in a first direction along the depth axis D, which is also the Z-axis of travel, so as to be arranged to face the painting surface S. The distance sensors are of a form known in the art such as those which operate using laser beams.

A pressure sensor 88 (schematically shown) is also located in the applicator nozzle 65A so as to provide the software with pressure measurements at the applicator nozzle. These pressure measurements may then be supplied to a closed loop subsystem which regulates the pressure at which paint is sprayed from the applicator nozzle. The nozzle pressure may be regulated by, for example, use of an applicator pump 90 (schematically shown) at the applicator nozzle. The applicator pump 90 is powered by a servo motor cooperating with the pressure sensor 88, which may in fact be a component of the servo motor. The applicator pump may be of the positive displacement pump variety and thus have similar characteristics to the transfer pumps 75 described hereinbefore.

As mentioned hereinabove, the reference shade or base shade of each constituent hue is achieved by spraying the paint at the prescribed or reference density thereof. The prescribed density of the paint for the reference shade is determined by a prescribed ratio of a pre-specified magnitude of the velocity of the paint applicator's applicator nozzle 65A about the surface S, which is typically user determined, and a reference pressure of the applicator nozzle for the pre-specified magnitude of the velocity. The reference pressure may also be determined by the pre-specified distance of the applicator nozzle from the surface, which is also user determined. In order to maintain consistent paint density for achieving the proper reference shade, the control system constantly balances an actual magnitude of the velocity of the paint applicator nozzle's motion about the surface and an actual pressure of the applicator nozzle in the spraying mode. The actual magnitude of the motion's velocity about the surface S is determined, for example, by direct measurement of this velocity or by calculating this velocity using velocity measurements in each of the respective axes of travel. Then, the pressure of the applicator nozzle is dynamically adjusted in respect of the measured actual motion velocity so as to maintain the prescribed ratio between the pre-specified magnitude of the motion velocity and the reference pressure. The motion velocity may be measured by arrangements known in the art such as by speed sensors and thus is not described further herein. Also, for example, the actual speed may be calculated by sampling the actual speeds in the X-axis, Y-axis, and Z-axis using a real-time filter as understood in the art, and deriving the speed of the net motion of the applicator nozzle about the surface S by taking the square root of the sum of the squares of the speeds in each of these axes of travel. Note that, at all times, the speed of the net motion is intended to remain constant and as close as possible to the pre-specified magnitude of the velocity of the motion. However, the pre-specified magnitude of the motion velocity may be changed or adjusted during the painting process, as deemed necessary (such as by the user), such that the robotic painting machine does not have to paint at the same speed for the entire painting process.

Shading as a functional operation is achieved by adjusting the applicator nozzle's pressure away from the reference pressure that is based on the prescribed ratio for the prescribed paint density for the reference shade. Shades of the respective hue are mapped to their own ratios of speed of applicator nozzle motion to nozzle pressure. Since the speed of the applicator nozzle about the surface S (i.e., surface speed of the nozzle) is maintained constant, the nozzle pressure is adjusted to achieve the appropriate shade. Typically, lighter shades of the respective hue are formed by decreasing the nozzle pressure (while maintaining the surface speed and distance from the surface), and darker shades of the respective hue are formed by increasing the nozzle pressure (keeping the surface speed and distance from the surface constant). As a shade of the constituent hue that is different from the reference shade is being applied, the surface speed and the pressure at the applicator nozzle for the particular shade are balanced as described in the previous paragraph (according to the ratio for the particular shade) in order to maintain consistent and proper application of this particular shade.

Note that the shading operation as described above may encompass ‘shadowing’ insofar as darker shades of the respective constituent hue that result from the reduction of light cast upon the particular portion of the image, as rendered within the image by the artist. Thus, ‘shadowing’ as a functional operation of the robotic painting machine and as described in the following paragraph constitutes a separate functional operation from shading which may provide artistic and visual effects for the reproduced image that are different from shading as described hereinbefore.

Thus, shadowing as the functional operation is achieved similar to how the shading operation is performed by the robotic painting machine. Shadowing is applied on areas of the surface S which have already been painted with at least one paint colour (excluding the white backing layer). Furthermore, the shadowing operation typically only comprises decreasing nozzle pressure, in contrast to the shading operation. Again, the surface speed and the pressure for the degree of shadowing being performed are balanced in order to maintain consistent and proper application of the shadowing.

Note that adjustment of the applicator nozzle's pressure for maintaining constant paint density or for achieving shading or shadowing is performed by the control system.

Also, as mentioned earlier, the actual nozzle pressure is regulated by employing the pressure sensor 88 and the servo motor to drive the applicator pump 90. The actual nozzle pressure is maintained within a predetermined pressure range which is with respect to the reference pressure at which the paint is being applied. This predetermined pressure range provides a tolerance relative to the reference pressure within which some variation in the actual pressure away from the reference pressure is acceptable. When the pressure sensor 88 senses that the actual pressure at the applicator nozzle 65A in the spraying mode falls outside the tolerable pressure range about the reference pressure, an output pressure of the applicator pump 90 is dynamically adjusted so that the actual pressure at the spraying applicator nozzle 65A returns to an acceptable pressure value within the tolerable pressure range about the reference pressure that is preferably as close as possible to the reference pressure. More particularly, the servo motor adjusts its speed in order to change the output pressure of the applicator pump 90. That is, the servo motor increases its speed in order to augment the pump output pressure such as if the output pressure falls below a lower pressure value of the tolerable range for the reference pressure. Accordingly, the servo motor decreases its speed in order to reduce the pump output pressure such as if the output pressure exceeds an upper pressure value of the tolerable range for the reference pressure. Even with use of the positive displacement pump type as the applicator pump 90, the actual nozzle pressure may shift from or oscillate about a steady value at which the pressure is intended to be maintained due to continued use of the robotic painting machine, over the course of which components of the applicator pump 90 may wear out and internal leakage of the applicator pump may begin to occur. For example, the actual nozzle pressure may also vary from the intended steady value if the applicator pump's output pressure exceeds a threshold pressure value above which internal leakage may occur. This control loop for regulating the nozzle pressure affords regulation of the actual nozzle pressure in a manner usable with either the applicator pump of the PDP variety or other pump types in which pressure may vary and may less consistent.

The dynamic adjustment of the applicator pump's output pressure occurs as the applicator pump 90 continuously transfers the paint to the spraying applicator nozzle 65A so long as the applicator nozzle is in the spraying mode. The applicator nozzle 65A may be switched from the spraying mode to a different operational mode like an idle mode such as in a scenario where the robotic painting machine carries a plurality of applicator nozzles, as will be described later.

During the step of applying the paint to the surface S, the motion of the robotic painting machine is managed so as to avoid collisions with the surface features F and other obstacles which may be in the path of the robotic painting machine 50A. When the scanning step has been performed prior to commencing the step of applying the paint, the distance sensors 86 are used to actively sense the presence of surface features unaccounted for, or in other words undetected, during the scanning step. The distance sensors 86 are actively sensing such ‘new’ obstacles as the robotic painting machine moves about the surface. If any new obstacles are detected, preventative action is initiated so as to avoid collision with same. Generally speaking, the unaccounted surface features and new obstacles protrude towards the applicator nozzle so as to be within the pre-specified distance at which the applicator nozzle is to be maintained from the surface S.

Alternatively, if the scanning step is not performed prior to applying the paint, the distance sensors 86 actively function to detect the surface features F which are protruding towards the applicator nozzle in a manner such that these surface features are within the pre-specified distance at which the applicator nozzle is to be maintained from the surface. If such surface features are detected, preventative action is initiated so as to avoid collision with same.

The preventative action to avoid collision includes retracting the applicator nozzle 65A away from the surface S and maneuvering the applicator nozzle of the paint applicator 60A about the protruding surface feature so as to paint over this surface feature. Such action comprises modifying at least one of the paint paths which the paint applicator is following to accommodate the surface feature while still accurately forming the image. Modification of the paint path may include addition of motion in one of the axes of travel, such as in the Z-axis in order to maintain the pre-specified distance from the surface or rotation of the applicator nozzle in the Theta axis to maintain aim of the nozzle normal to side of a protruding surface feature and to paint sides thereof.

Alternatively to painting over the protruding surface feature, the preventative action includes retracting the applicator nozzle away from the surface S and moving the applicator nozzle of the paint applicator past the surface feature so as to omit the surface feature from painting thereover. For example, certain surface features may not be paintable such as windows, electrical cables, or pipes. The control system can be configured for automatic management of such non-paintable surface features, like those examples listed, according to one of or a combination of the possible preventative actions, or manual management of such obstacles in which the user is prompted to select a preventative action for an obstacle. Omission of a surface feature may also cause to modify at least one of the paint paths.

All the while, the distance information provided by the distance sensors 86 is used to maintain the pre-specified distance from the surface S at all locations along the surface so that an accurate image is reproduced.

When the first one of the image sections 82 has been completed, the base 66 is moved longitudinally along the applicator mount 40A so as to be located at an adjacent one of the image sections. Again, the image layers lying within the adjacent one of the image sections are applied one at a time.

The process is repeated such that the robotic painting machine 50A is moved longitudinally along the applicator mount 40A until one row of image sections 82 has been completed. Then, the applicator mount 40A is moved longitudinally along the tracks 20A, 30A so as to locate the robotic painting machine at the adjacent row of image sections 82. Again, each one of the image sections of the respective row is painted in succession, one by one.

In this manner, details of the image can be accurately reproduced by minimizing a number of movement sequences of the robotic painting machine 50A along the applicator mount 40A and movement sequences of the applicator mount 40A along the tracks 20A, 30A which are less precise than the motion of the applicator nozzle 65A about the surface S.

When the image has been fully reproduced, the robotic painting machine is removed from the applicator mount, the applicator mount disconnected from the tracks, and the tracks released from attachment to the surface S. To be ready for being transported, the support boom 68 of the robotic painting machine is moved to the end base portion 66B and the pins securing the end base portion in the first aligned position are removed so that the support boom 68 can be laid down in the transport position as the end base portion 66B is moved to the second folded position.

In other embodiments, the robotic painting machine may be manually positioned at the surface S of the structure by a support arrangement such as a crane or a fork lift so as to be free of the tracks and applicator mount. Such manual positioning may be implemented when painting an image onto a rounded surface such as that of a water tower. Furthermore, if the area A to be painted is sufficiently small such that the area is coverable by the full range of movement of the robotic painting machine (that is, the area to be painted is less than or equal to the paint coverage area of the robotic painting machine), then the robotic painting machine is positioned in a single stationary position from which the entirety of the image may be reproduced.

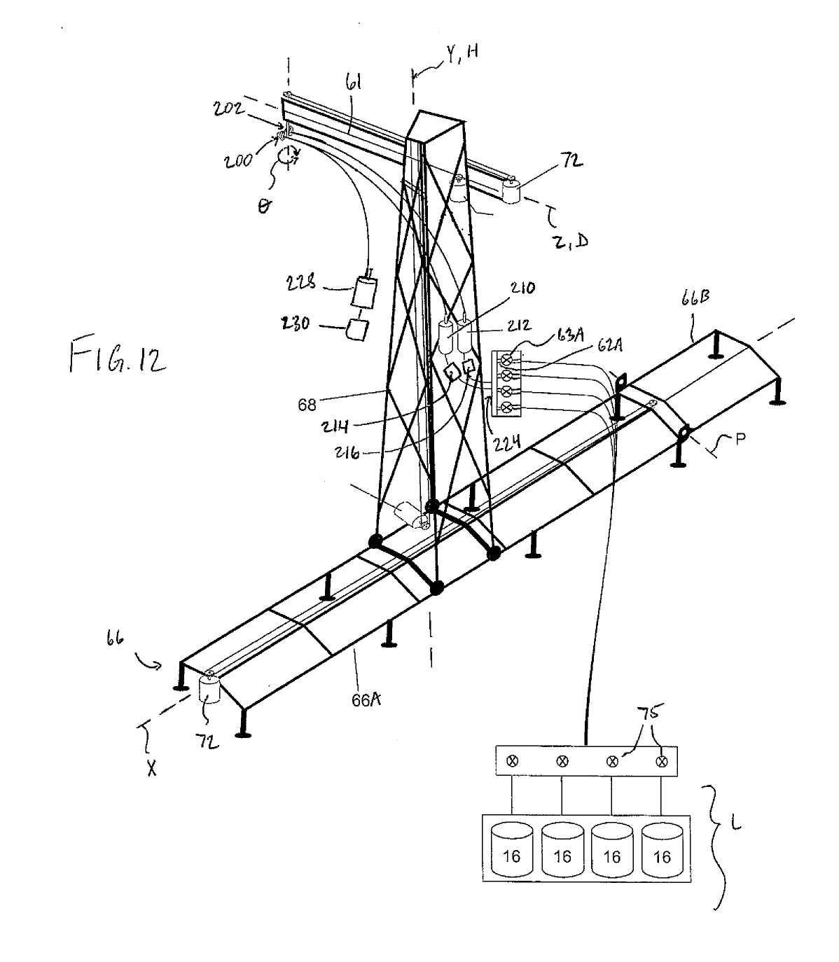

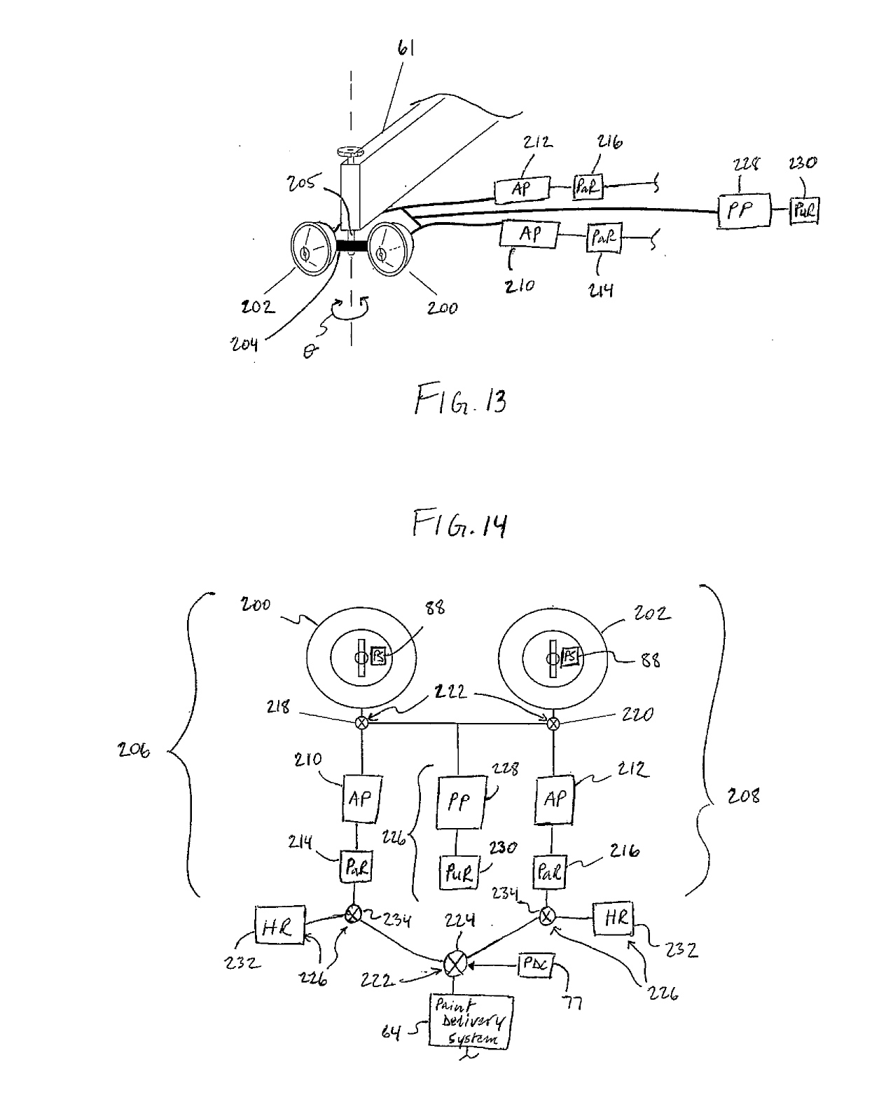

In the second illustrated embodiment as indicated at 50A′ and more clearly shown in FIGS. 12-14, the robotic painting machine 50A′ has two applicator nozzles 200, 202 carried on the painting arm 61. This embodiment of the second illustrated arrangement is referred to as ‘multiple nozzle embodiment’ for convenience of description hereinafter. Furthermore, the applicator nozzles have similar structure and functionality like the applicator nozzle indicated at 65A; however, the two applicator nozzles are labelled with difference reference numerals as they are discussed with reference to the multiple nozzle embodiment and not the former embodiment. Note that the components of the automated paint application system which are not discussed in detail expressly with reference to the multiple nozzle embodiment are similar in structure and functionality to the components described expressly with reference to the first embodiment of this second arrangement.

Returning to the description of the multiple nozzle embodiment, each of the two applicator nozzles 200, 202 may be of a same type of painting nozzle so as to have same painting characteristics or parameters, including spray pattern. Alternatively, the plurality of applicator nozzles may be selected such that each applicator nozzle has a unique spray pattern. For example, a first nozzle may have a fine spray pattern suited for applying the contour or outline of the working portion of the respective image layer and a second nozzle may have a coarse spray pattern suited for efficiently applying the paint within the working portion's contour.

Turning to the structure of the multiple nozzle arrangement in more detail, the pair of applicator nozzles 200, 202 are arranged side-by-side on an elongate nozzle support member 204 forming a short beam transverse to the painting arm 61. The nozzle support member 204 is pivotally supported on the painting arm 61 by a shaft 205 extending from the painting arm 61 thereby providing movement of the pair of applicator nozzles in the Theta-axis. As such, each applicator nozzle 200, 202 is located at transversely offset positions disposed outwardly of the painting arm 61.

As schematically shown in FIG. 14, each applicator nozzle 200, 202 forms a nozzle assembly, respectively indicated at 206 and 208. In addition to the respective applicator nozzle, each nozzle assembly 206, 208 also includes an applicator pump on an inlet side of the applicator nozzle, respectively indicated at 210 and 212, and a paint reservoir respectively indicated at 214 and 216 on an inlet side of the respective applicator pump for containing paint in proximity to the respective applicator nozzle 200, 202. The applicator pumps 210, 212 are of the same variety as the applicator pump indicated at 90 that is described in conjunction with the single nozzle embodiment (i.e., POP). Also, the paint reservoir 214, 216 is suited for temporarily storing the paint, which has already passed through the paint delivery system 64 and thus the colour mixing system, to be applied to the surface S by the respective applicator nozzle 200, 202. Additionally, the applicator nozzle, applicator pump, and paint reservoir of each nozzle assembly are connected to one another as described above by hoses or tubing and any necessary valves in a manner known to a person with normal skill in the art. Furthermore, a nozzle valve 218, 220 is located intermediate the respective applicator nozzle 200, 202 and the respective applicator pump 210, 212 to control the flow of paint material from the applicator pump to the applicator nozzle. Thus, each nozzle assembly contains enough components for supplying the respective applicator nozzle 200, 202 with paint for spraying in the spraying mode thereof such that the nozzle assemblies are usable independently of one another. That is, although both applicator nozzles 200, 202 are not simultaneously used in the spraying mode in the illustrated arrangement, each nozzle assembly is operable by the control system 70 (so as to be used thereby) in order to perform parallel tasks. For example, the first applicator nozzle 200 may be operating in the spraying mode so as to be actively spraying paint while the second applicator nozzle 202 which is in an idle mode (i.e., not spraying) may be queued for spraying a next paint colour.

The second embodiment 50A′ includes a nozzle selection assembly 222 which selectively controls flow of paint to each of the applicator nozzles. As such, the nozzle selection assembly operatively and selectively couples each one of the nozzle assemblies to the paint delivery system 64. That is, each nozzle assembly on an inlet side of the respective paint reservoir 214, 216 is selectively communicated with the paint delivery system 64 by a valve arrangement 224 of the nozzle selection assembly 222 as schematically shown in FIG. 14. The valve arrangement 224 is of a type known in the art and thus not described in detail herein. Also, the nozzle selection assembly may be considered to include the nozzle valves 218 and 220.

The valve arrangement 224, which is controlled by a controller such as the paint delivery controller 77, is operable in a first nozzle assembly mode in which the paint colour passed through the paint delivery system is transferred to the first paint reservoir 214 of the first nozzle assembly 206 that includes first applicator nozzle 200 and in a second nozzle assembly mode in which the paint colour is transferred to the second paint reservoir 216 of the second nozzle assembly 208 that includes the second applicator nozzle 202. That is, in the first nozzle assembly mode the paint delivery system and the first nozzle assembly are communicated, and in the second nozzle assembly mode the paint delivery system and the second nozzle assembly communication. In such a manner as described in this paragraph, the paint delivery system is operable in a first mode in which a first one of the nozzle assemblies is selected so as to transfer the paint thereto and in a second mode in which a second one of the nozzle assemblies is selected so as to transfer the paint thereto.

Thus, the paint delivery system 64 may supply a plurality of the nozzle assemblies and is operable to selectively transfer the combination colour to one of the nozzle assemblies independently of the other nozzle assembly. This feature and the structure of the nozzle assemblies may afford one of the two applicator nozzles to be usable in the spraying mode for actively spraying a first paint colour corresponding to the working portion of the image layer at which the robotic painting machine is operating and, in the meantime, another one of the two applicator nozzles, which is inactive (i.e., not spraying paint) and in the idle mode, is usable for queuing a second paint colour of another image layer that is different from the first paint colour.

As alluded to earlier, one of the applicator nozzles that is in the idle mode may be queued for applying paint which forms a paint colour different from that being currently applied by the other applicator nozzle which is in the spraying mode. This queuing step may be performed in parallel with the step of applying the paint to the surface S such that the applicator nozzle in the idle mode is readied for operating in the spraying mode. These parallel operations may be realizable in the manner described in the following paragraph.

In use, the first paint reservoir 214, which contains a sufficient amount of the current paint colour to cover the corresponding image layer at the image section at which the robotic painting machine is currently working, continuously supplies the first applicator nozzle 200 in the spraying mode and is disconnected from (i.e., not communicated with) the paint mixing system. As the first applicator nozzle 200 sprays its paint, the second paint reservoir 216 upstream of the second applicator nozzle 202, which is in the idle mode, is connected to the paint delivery system operating in the second nozzle assembly mode and the next paint colour which is to be applied to the surface S is transferred into the second paint reservoir 216 so that the second applicator nozzle is ready to apply the second paint colour once the robotic painting machine 50A′ has completed the current image layer at the image section and is ready to apply the next image layer thereat. Once an entirety of the next paint colour has been transferred into the second nozzle assembly, the second applicator nozzle may be considered to be in a standby mode when its ready for spraying the next paint colour, as a remaining operation left to be performed is to switch the nozzle valve 220 to the appropriate position so as to communicate the applicator pump 212 and the second applicator nozzle 202 once the first applicator nozzle is finished spraying its paint.

In such a manner as described in the previous paragraph, the next paint colour may be loaded into the nozzle assembly corresponding to the applicator nozzle which is in the idle mode. As such, use of the multiple nozzle setup may reduce an amount of time which elapses for switching between different constituent hues of the image such that the painting process is expedited. Note that the nozzle valves 218, 220 are operated in a manner such that such that the respective applicator pump and respective applicator nozzle are communicated for the nozzle in the spraying mode. The nozzle valve is positioned such that the respective applicator pump and respective applicator nozzle are not communicated for the nozzle in the idle mode.

The second embodiment 50A′ also includes a purging assembly 226 operatively coupled to the nozzle assembly and arranged for transferring a purging fluid through the nozzle assembly so as to remove paint residue therefrom. In other words, the purging assembly is provided for cleaning or flushing each of the nozzle assemblies 208, 210 so as to remove at least a majority of residue of the former colour of paint which was being sprayed such that contamination of the former paint colour with subsequent colours of paint to be sprayed afterwards may be resisted.

The purging assembly 226 comprises a purging reservoir 228 (schematically shown) containing unused purging fluid, such as a gas like air or a liquid like water, and a purging pump 230 (schematically shown) for transferring the purging fluid into the nozzle assemblies 206, 208. An output of the purging pump 230 is connected to each of the nozzle valves 218 and 220 so as to be connected to a nozzle outlet side of the respective applicator pump 210, 212. The purging pump may be of the PDP variety so as to provide more controlled amounts of the purging fluid for purging operations, as will be described in more detail later.

To provide the necessary functionality, the nozzle valves 218, 220 comprise multi-port valves having a structure known in the art. Each of the multi-port nozzle 220, 222 valves is operable in (i) a first paint dispensing mode in which the output of the respective applicator pump is communicated with the applicator nozzle, as in the spraying mode, and flow from the purging pump is obstructed; (ii) a second purging mode in which the purging pump is communicated with the respective applicator pump and flow to or from the applicator nozzle is impeded, with the respective applicator nozzle being in the idle mode; and (iii) a third blocking mode in which the output of the respective applicator pump is not communicated with the applicator nozzle nor with the purging pump such that the respective applicator nozzle is in the idle mode.

Furthermore, the purging assembly includes at least one holding reservoir 232 (schematically shown) for containing used purging fluid and storing same. The at least one holding reservoir 232 is connected to the respective nozzle assembly 208, 210 such as by a dumping valve 234 (schematically shown). The dumping valve 234 is operable so as to permit or obstruct communication between the nozzle assembly and the purging reservoir. It will be appreciated that the purging fluid, once it passes through the respective nozzle assembly so as to purge same and is thus considered used, collects in the holding reservoir 232 and is maintained separately from the paints 16 so as to prevent contamination with same. In the illustrated arrangement, the dumping valve 234 is a separate element from the valve arrangement 224 controlling flow between the paint delivery system and one of the nozzle assemblies. However, the dumping valve 234 is located in proximity to this valve arrangement 224 such that a length of hose or tubing therebetween is also cleansable by the purging assembly 226 to remove paint residue.

The purging assembly 226 is operable on one of the nozzle assemblies 206, 208 in the idle mode in parallel with spraying paint using the other nozzle assembly in the spraying mode. A purging operation is typically performed prior to queuing a different paint colour into the respective nozzle assembly. In general, the purging operation is used to remove paint residue from the respective nozzle assembly prior to using the applicator nozzle of this nozzle assembly for application of a paint colour different than a previous paint colour which was applied by said applicator nozzle.

After one of the applicator nozzles has finished applying one paint colour, the respective multi-port valve 218, 220 is operated in the second purging mode so as to communicate the purging reservoir 230 and purging pump 228 with the respective grouping of the applicator pump and paint reservoir. Also, the dumping valve 234 is operated so as to communicate the respective paint reservoir 214, 216 with the holding reservoir 232. The purging pump 228 is operated so as to transfer the purging fluid into the applicator pump, which is operated in a reverse direction with respect to a conventional direction of paint flow through the nozzle assembly for delivering paint to the respective applicator nozzle. Thus, the purging assembly cooperates with the nozzle assembly in order to transfer the purging fluid through the nozzle assembly in the reverse direction, particularly through the applicator pump and paint reservoir and the paint residue of the former paint colour is substantially removed. For each purging operation, a predetermined amount of the purging fluid is passed through the respective nozzle assembly to sufficiently clean same.

When the purging operation is completed, such as when the predetermined amount of the purging fluid has been transferred through the nozzle assembly, the respective multi-port nozzle valve 220, 222 may be positioned in the third blocking mode and the holding reservoir 232 may be disconnected from the respective paint reservoir 214, 216. Then, the respective nozzle assembly 206, 208 which was purged may be communicated with the paint delivery system 64 so as to prepare this nozzle assembly for the next paint colour to be applied as the respective applicator nozzle remains in the idle mode.

Once the other applicator nozzle 202, 200 is finished spraying its paint, its multi-port nozzle valve 220, 218 may be switched from the first paint dispensing mode to the second purging mode thereby allowing this other nozzle assembly to be purged and placing the respective applicator nozzle 202, 200 in the idle mode. As the multi-port nozzle valve of the other applicator nozzle switches operation, the first multi-port nozzle valve is switched from the third blocking mode to the first paint dispensing mode thereby placing the respective applicator nozzle in the spraying mode.

The control system 70 manages tasks of active spraying with one of the applicator nozzles and queuing the other applicator nozzle. The control system may also determines which paint colour is the next paint colour to be queued. The control system also manages a task of purging or cleaning. More particularly, operation of the nozzle valves 218, 220 may be controlled by the applicator controller 78. The applicator controller may also direct the applicator pumps 210, 212 and the purging pump 228.

Given the offset positions of the two applicator nozzles 200 and 202, the control system 70 tracks which applicator nozzle is being used in the spraying mode and accounts for the respective applicator nozzle's position relative to the painting arm when performing actions such as moving this applicator nozzle in the Theta-axis and maintaining the pre-specified distance from the surface S and the surface features F.

Also, the hoses or tubing operatively coupling the nozzle assemblies, nozzle selection assembly, and purging assembly are arranged for displacement of the two applicator nozzles in the Theta axis such as by having sufficient slack in the hoses or tubing.

Note that the first embodiment 50A of this second arrangement of robotic painting machine, as illustrated, may also be considered to have a nozzle assembly. In this case, the nozzle assembly of the single nozzle embodiment comprises the applicator nozzle 65A, the applicator pump 90, and the paint reservoir being which may be defined by, for example, the single conduit into which the plurality of paint conduits 62A converge.

Also, note that the purging assembly may be incorporated with the single nozzle embodiment including a nozzle valve, such as that described and indicated at 218 or 220, provided at a location intermediate the applicator nozzle 65A and the applicator pump 90 in order to provide proper functionality.

In summary, the robotic painting machine comprises a robot suited for painting large images including murals and advertisements on paintable surfaces (i.e., surfaces which can receive and retain paint thereon) by spraying liquids such as paint. For example, the robotic painting machine may also spray moss spores onto a porous surface so as to form a phrase of words or pictorial representation thereon. Additionally, the paintable surfaces may include that of upright, structures such as large residential or commercial buildings, water towers, grain storage buildings; corrugated surfaces like those on security doors, rail cars, and shipping containers or sea cans; semi-truck trailers; and grass especially as that on an inclined side of a mound or hill.

The robotic painting machine is suited for use in uncontrolled environments, meaning that not all features of the surface S may be known in advance of spraying the paint onto the surface or that new obstacles which impede or obstruct the painting process may appear on the surface. Thus, the machine has to be able to manoeuver about the surface and manage the image in respect of the surface. As such, the robotic painting machine is required to adapt the painting process which includes the motion of the applicator nozzle at the surface S and movement of the machine along the applicator mount.

Therefore, conversion into the vectorized format is required for continuous movement of the applicator nozzle about the paintable surface. If an instance occurs in which a portion of an area on the surface corresponding to a particular image section is obstructed by a miscellaneous object such as a pipe or electrical cable, the control system must be able to decide how to manage this obstacle. This is only possible when each infinitesimal point of the image is mapped by a vector as in the vectorized format so that each point of the image can be managed independently of one another. That way, only the portion of the image which is obstructed has to be handled differently while the remaining image can be applied in a conventional fashion, that is, free of implementing ‘obstacle management’. This is unlike the bit-mapped format, like the pixel-based or raster format, in which an adjoining set of such infinitesimal points of an image are collectively grouped together in a single pixel such that when a portion of one pixel of the image is obstructed, the entirety of that one pixel likely has to be changed to accommodate the obstacle if such accommodation is at all possible.

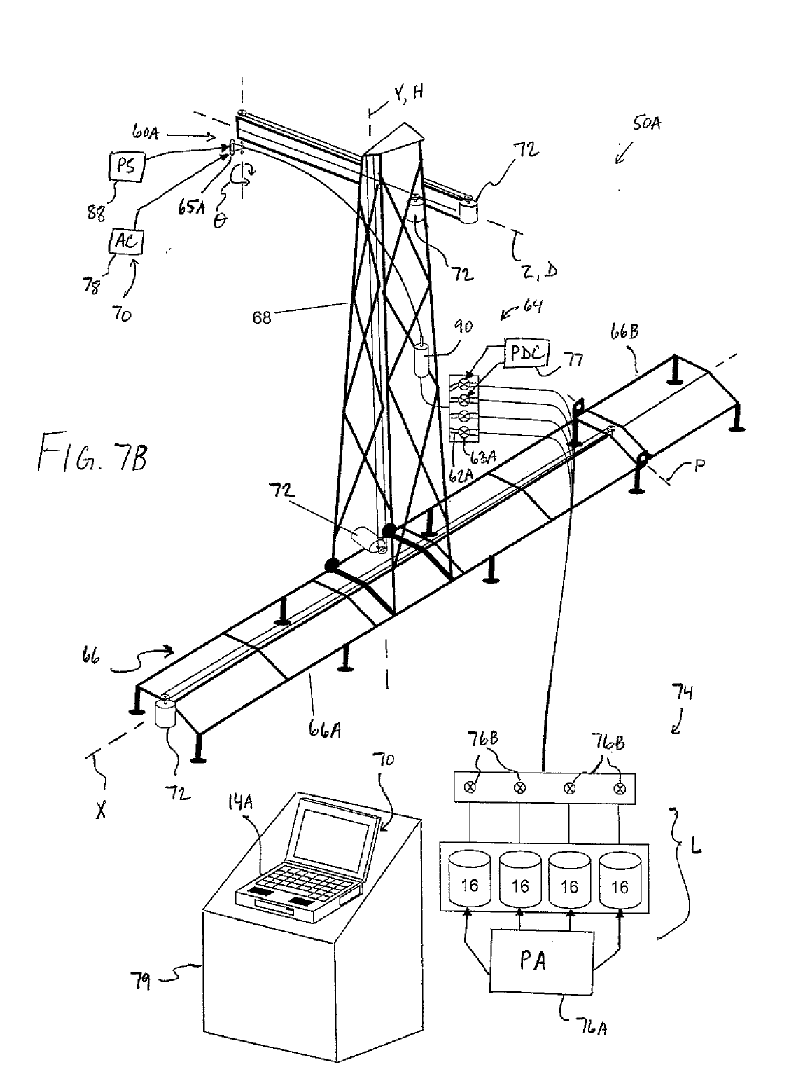

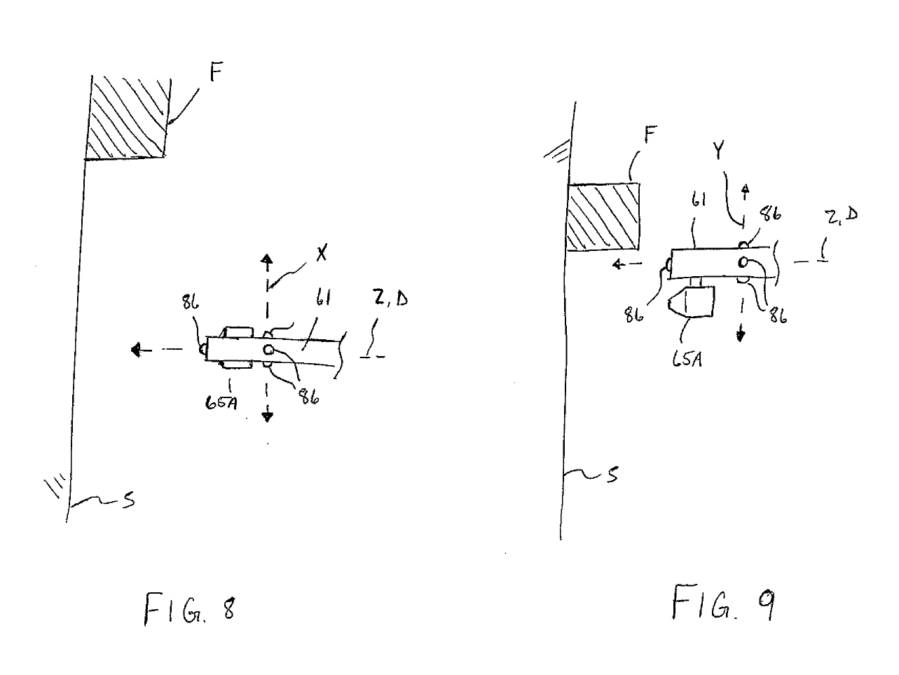

Note that the aforementioned parts and “in use” steps mentioned expressly with reference to the second illustrated arrangement of FIGS. 6-14 may be incorporated and used with the first illustrated arrangement of FIGS. 1-5.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods and materials are described above. In case of conflict, the present specification, including definitions, will control.

Since various modifications can be made in my invention as herein above described, and many apparently widely different embodiments of same made, it is intended that all matter contained in the accompanying specification shall be interpreted as illustrative only and not in a limiting sense.

1. A method for reproducing a high resolution image on an area of a surface in an uncontrolled environment through application of paint on said surface comprising:
providing the image in a format which is storable on a computing device having memory, the image having one or more constituent hues each including at least one shade and at least one level of saturation;
providing an automated paint application system for applying the paint to the surface, the automated paint application system including:
a robotic painting machine comprising a base and a paint applicator supported thereon in a manner so as to be movable relative to the base;
the paint applicator carrying at least one applicator nozzle for spraying the paint onto the surface in a spraying mode of said at least one applicator nozzle;
a control system actively directing one of said at least one applicator nozzle that is in the spraying mode about the surface in the uncontrolled environment;
preparing the image for reproduction on the surface including:
processing the image into a vectorized format usable by the automated paint application system;
generating one or more paint paths which collectively form the image with the vectorized format thereof, each paint path having one of said constituent hues of the image and a respective spatial path about the surface and being usable by the control system of the automated paint application system in a manner so as to be traceable on the surface in continuous motion of the paint applicator;
applying the paint onto the surface using the automated paint application system by following said one or more paint paths so as to form the image.

2. (canceled)

3. The method according to claim 1 wherein the step of preparing the image comprises a step of dividing the image into a plurality of image sections on the area of the surface on which the image is to be applied.

4. (canceled)

5. The method according to claim 3 wherein the image sections are sized such that movement of the robotic painting machine from a first position thereof at one of the image sections to a second position of the robotic painting machine located at another one of the image sections adjacent thereto is minimized.

6. The method according to claim 3 wherein the step of applying the paint comprises reproducing each image section one by one.

7. The method according to claim 6 wherein the step of preparing the image comprises a step of processing the image into a plurality of image layers each of which is defined by one of the constituent hues of the image such that at least one paint path forms one of the image layers and the step of applying the paint comprises applying the image layers at one of the image sections prior to reproducing another one of the image sections.

8. The method according to claim 1 wherein the step of preparing the image comprises a step of processing the image into a plurality of image layers each of which is defined by one of the constituent hues of the image such that at least one paint path forms one of the image layers and the step of applying the paint comprises applying each image layer one by one.

9. The method according to claim 1 wherein the step of preparing the image further comprises a step of processing the image into a plurality of image layers each of which is defined by one of the constituent hues of the image such that at least one paint path forms one of the image layers and the step of processing the image into the plurality of image layers includes mapping said at least one shade within each image layer.

10. The method according to claim 1 wherein the step of applying the paint comprises a step of balancing an actual magnitude of velocity of the continuous motion of the paint applicator about the surface and an actual pressure of the one of said at least one applicator nozzle in the spraying mode for maintaining a consistent density of the paint which is applied based on a ratio of a pre-specified magnitude of the velocity of the motion of the paint applicator about the surface and a reference pressure of said applicator nozzle in the spraying mode for said pre-specified magnitude of the velocity.

11. The method according to claim 10 wherein the step of balancing the actual magnitude of the velocity of the motion of the paint applicator and the actual pressure of said applicator nozzle in the spraying mode comprises determining the actual magnitude of the velocity of the motion about the surface and adjusting the pressure of said applicator nozzle in the spraying mode to maintain the ratio of the pre-specified magnitude of the velocity of the motion and the reference pressure of said applicator nozzle.

12. The method according to claim 1 wherein the step of applying the paint comprises a step of adjusting a pressure of the one of said at least one applicator nozzle in the spraying mode to produce the respective shade of the respective constituent hue while said applicator nozzle in the spraying mode is maintained at a pre-specified distance from the surface.

13. The method according to claim 12 wherein the step of adjusting the pressure of said applicator nozzle in the spraying mode to produce the respective shade comprises changing said pressure of said applicator nozzle in the spraying mode from a reference pressure thereof which is based on a pre-specified magnitude of velocity of the continuous motion of the paint applicator about the surface for maintaining a prescribed density of the paint which is applied.

14. (canceled)

15. (canceled)

16. (canceled)

17. The method according to claim 1 comprising a step of scanning the surface in first and second dimensions collectively defining a plane which is substantially parallel to the surface and in a third dimension normal to the surface using distance sensors disposed on the robotic painting machine to detect surface features as the robotic painting machine is displaced about the surface in said plane so as to provide a map of the surface features in the first, second, and third dimensions.

18. (canceled)

19. (canceled)

20. The method according to claim 1 wherein the step of applying the paint comprises a step of managing the motion of the paint applicator relative to the surface so as to avoid collision therewith by using distance sensors which are disposed on the robotic painting machine during movement of the robotic painting machine about the surface to detect surface features which protrude towards the one of said at least one applicator nozzle in the spraying mode in a manner so as to be within a pre-specified distance at which the applicator nozzle is to be maintained from the surface and to initiate preventative action to avoid the collision.

21. The method according to claim 20 wherein the preventative action includes retracting said applicator nozzle in the spraying mode away from the surface and maneuvering the paint applicator about the protruding surface feature so as to paint over said surface feature thereby modifying at least one of the paint paths.

22. The method according to claim 20 wherein the preventative action includes retracting said applicator nozzle in the spraying mode away from the surface and moving the paint applicator past the protruding surface feature so as to omit said surface feature from painting thereover.

23. (canceled)

24. (canceled)

25. The method according to claim 1 wherein said at least one applicator nozzle forms a nozzle assembly which includes an applicator pump and a paint reservoir for containing paint in proximity to said at least one applicator nozzle that are located at an inlet side thereof and there is provided a step of purging the nozzle assembly so as to remove paint residue therefrom prior to using said applicator nozzle for application of paint forming a respective one of the constituent hues different than a previous one of the constituent hues which was applied by said applicator nozzle.

26. The method according to claim 1 wherein said at least one applicator nozzle comprises two applicator nozzles one of which is in the spraying mode in order to actively perform the step of applying the paint onto the surface and another one of which is in an idle mode and there is provided a step of queuing said another one of the two applicator nozzles in the idle mode for application of paint forming another one of the constituent hues of the image different from a current one of the constituent hues being applied that is performed in parallel with the step of applying the paint onto the surface.

27. (canceled)

28. The method according to claim 26 wherein the step of queuing said applicator nozzle in the idle mode comprises a step of transferring said another one of the constituent hues of the image which is different from the current one of the constituent hues being applied into the nozzle assembly having said applicator nozzle which is in the idle mode such that said applicator nozzle in the idle mode is readied for operating in the spraying mode.

29. The method according to claim 1 wherein the step of applying the paint comprises a step of regulating an actual pressure of the one of said at least one applicator nozzle in the spraying mode within a predetermined pressure range which is with respect to a reference pressure of said applicator nozzle in the spraying mode for maintaining a consistent density of the paint which is applied.

30. The method according to claim 29 wherein the robotic painting machine includes an applicator pump which generates pressure at the one of said at least one applicator nozzles in the spraying mode and the step of regulating the actual pressure of said applicator nozzle in the spraying mode comprises adjusting an output pressure of the applicator pump based on the actual pressure determined at said applicator nozzle.

31. A robotic painting machine for reproducing a high resolution image on an area of a surface in an uncontrolled environment through application of paint on said surface comprising:
a base which is elongate in a longitudinal axis along the surface;
an upstanding support boom carried on the base so as to be movable along the longitudinal axis of the base;
a paint applicator supported on the upstanding support boom in a manner so as to be movable across a height axis of the support boom which is transverse to the longitudinal axis of the base;
the paint applicator including at least one applicator nozzle for spraying the paint onto the surface in a spraying mode of said at least one applicator nozzle that is carried on a painting arm;
the painting arm being movably supported on the support boom so as to be movable in a depth axis which is transverse to the height axis of the support boom and to the longitudinal axis of the base;
a paint delivery system operatively connected to said at least one applicator nozzle for transferring the paint thereto;
a drive system operatively coupled to each one of the upstanding support boom, the paint applicator, and the painting arm for driving movement thereof;
and a control system directing motion of one of said at least one applicator nozzle in the spraying mode about the surface in the uncontrolled environment.

32. The robotic painting machine according to claim 31 wherein said at least one applicator nozzle is pivotally supported on the painting arm so as to be movable about an upstanding axis which is transverse to the depth axis and parallel to the height axis of the support boom for aiming said at least one applicator nozzle substantially normal to the surface.

33. (canceled)

34. (canceled)

35. The robotic painting machine according to claim 31 comprising a plurality of distance sensors disposed at strategic locations at or adjacent a distal end of the painting arm so as to be near said at least one applicator nozzle for detecting obstacles in a path of motion of the one of said at least one applicator nozzle in the spraying mode, said strategic locations including first and second locations facing in each direction along the longitudinal axis of the base, third and fourth locations facing in each direction along the height axis of the support boom, and a fifth location facing in a first direction of the depth axis that is arranged to face the surface.

36. The robotic painting machine according to claim 31 wherein said at least one applicator nozzle forms a nozzle assembly which includes an applicator pump and a paint reservoir for containing paint in proximity to the respective applicator nozzle that are located at an inlet side of the respective applicator nozzle and there is provided a purging assembly operatively coupled to the nozzle assembly and arranged for transferring a purging fluid through the nozzle assembly so as to remove paint residue therefrom.

37. The robotic painting machine according to claim 36 wherein the purging assembly comprises a purging pump and a purging reservoir for containing unused purging fluid that are connected to a nozzle outlet side of the applicator pump in order to cooperate with the nozzle assembly so as to transfer the purging fluid therethrough in a reverse direction with respect to a conventional direction of paint flow through the nozzle assembly.

38. The robotic painting machine according to claim 31 wherein said at least one applicator nozzle comprises two applicator nozzles each forming a nozzle assembly which includes an applicator pump and a paint reservoir for containing paint in proximity to the respective applicator nozzle that are located at an inlet side of the respective applicator nozzle such that the nozzle assemblies are usable independently of one another in a manner such that the respective nozzle assembly having one of the applicator nozzles in an idle mode is operable while said one of the applicator nozzles in the spraying mode is actively spraying the paint.

39. (canceled)

40. An automated paint application system for application of paint to an upright structure in a manner so as to form an image on the upright structure that has different colours comprising:
at least one track;
a fastening arrangement for removably securing said at least one track in fixed position extending along said upright structure;
an applicator mount movably secured to said at least one track so as to be movable relative to said upright structure;
a paint applicator for applying the paint to the upright structure that is secured to said applicator mount so as to be movable relative thereto for movement relative to the upright structure, the paint applicator including:
an applicator nozzle;
a plurality of paint conduits each connected by a valve to the applicator nozzle that are usable for respectively transferring a different coloured paint;
and a controller operable to selectively control the valves of the respective paint conduits for dispensing the paint that is transferred by the respective paint conduit;
said controller being operable in a first mode such that one of the different coloured paints is selectable and in a second mode such that a combination colour is formed including in combination two or more of the paints from the paint conduits.

41. The automated paint application system of claim 40 wherein the plurality of paint conduits converge to a single conduit which terminates at the applicator nozzle.
